(19) United States
(12) Patent Application Publication
(10) Pub. No.: US 2022/0147585 A1
(43) Pub. Date: May 12, 2022

(54) SYSTEMS AND METHODS FOR CATEGORICAL REPRESENTATION LEARNING

(71) Applicant: QGNai Inc., Cambridge, MA (US)

(72) Inventors: Artan Sheshmani, Cambridge, MA (US); Yizhuang You, La Jolla, CA (US)

(21) Appl. No.: 17/518,313

(22) Filed: Nov. 3, 2021

Related U.S. Application Data
(60) Provisional application No. 63/110,906, filed on Nov. 6, 2020.
(60) Provisional application No. 63/168,171, filed on Mar. 30, 2021.

(51) Int. Cl. G06F 16/954; G06F 40/205; G06F 40/268; G06F 40/58

(52) U.S. Cl. CPC G06F 16/954; G06F 40/58; G06F 40/268; G06F 40/205

(57) ABSTRACT

Systems and methods for machine learning are provided. Object embeddings obtained for a dataset comprise a plurality of objects of a first category. Each object embedding represents properties of a corresponding object. Object embeddings are used to determine morphism embeddings for morphisms. Each morphism embedding represents a morphism between a corresponding first and second object in the dataset. A morphism embedding, when multiplied by the object embedding of the corresponding first object, realizes with threshold probability the object embedding of the corresponding second object. Linking probabilities are determined between pairs of objects in the dataset using morphisms between the pairs of objects. Composite objects are added to the plurality of objects for pairs of objects when their linking probabilities exceed thresholds. For a query comprising a set of objects in the first category, all or a portion of the plurality of objects, including composite objects, identify a query match.

### CROSS REFERENCE TO RELATED APPLICATION

This application claims priority to U.S. Provisional Patent Application No. 63/168,171, entitled “Systems and Methods for Categorical Representation Learning,” filed Mar. 30, 2021 and U.S. Provisional Patent Application No. 63/110,906, entitled “Systems and Methods for Categorical Representation Learning,” filed Nov. 6, 2020, each of which is hereby incorporated by reference.

### TECHNICAL FIELD

This specification relates generally to improved methods of machine learning using categorical representations.

### BACKGROUND

Algorithms, such as search engines, use an object-oriented approach. Because computers operate as mathematical machines, in order to achieve the object-oriented approach, each word in a phrase evaluated by a search engine is mapped to a mathematical construct (e.g., a mathematical object such as a vector) so that the computer can work with them. So, if an algorithm running on a computer parses an input passage (search query) using natural language processing, each word in the input passage (e.g., “I am Arton, I live in Boston”), is assigned to a mathematical construct, such as a vector inside a vector space.

In the case of search engines, each word in the search query gets mapped to a vector in the vector space, resulting in numerous vectors in the vector space. Consider an input passage of ten words. Each word gets mapped to a vector, and there will be ten different vectors, each in a different direction in the vector space.

Further consider the case where a user wants to search an image associated with the text. Images are also mapped to mathematical constructs. Therefore, if the algorithm wants to find a connection between the search sentence and images, this is mathematically resolved as having a first set of mathematical constructs (e.g., vectors) in a first category (text vectors) and another set of mathematical constructs (e.g., vectors) in a second category (images) and the task of matching text to images is reduced to looking for mathematical constructs (e.g., vectors) in the first category (text vectors) that are aligned with mathematical constructs (e.g., vectors) in the second category (images). This is termed aligning and is also referred to as an object-oriented approach.

While such object oriented approaches have had profound implications in applications such as search engines, there are drawbacks. Object-oriented approaches (e.g., implemented in conventional search engines), look at all words flatly with the same rank, meaning that they do not prioritize any word in the input phrase over any other word. Thus, for many search queries, satisfactory matches are not found. Moreover, object-oriented approaches can require very complex graphs to resolve search queries. Accordingly, what is needed in the art are improved systems and methods for performing machine learning algorithms, such as search engines.

### SUMMARY

The present disclosure addresses the shortcomings identified in the background by making use of relationships between such objects, in addition to assigning objects (e.g., words, pictures, etc.) to mathematical constructs, such as vectors. Consider when a human is interpreting a sentence. A human doesn't just look at every word in the sentence just flatly. The human uses the relations between words. This is what a human does to understand the sentence. Here is an example, “The book is normally in the bookshelf. The bookshelf is in the living room. Where is the book?” The human looks at the relations within this passage and would, from these relations, conclude that the book is in the living room because the passage that says that, normally the book is in the bookshelf and the bookshelf is in the living room so the book normally is in the living room. That is, the human consequences a logical reasoning to guess where the book is. The way the human did this was by looking at the relations between words. But this is something that existing algorithms (e.g., search engines), as discussed in the background, do not presently do. Thus, contrary to conventional methods in which each word is considered flatly, in the approaches of the present disclosure, certain aspects of the input passage are prioritized. The ambient thing that is more important is the rule: which room was it? the living room. That rule has more priority than the rest of the search query because the living room contains the bookshelf. The logic and analysis of the passage causes the human to guess where the book: ok, the book is normally in the bookshelf, the book is in the living room. Such analysis gives priority, rankings, to the meaning of specific word combinations or relations. Much like a human reasons, the present disclosure expands the conventional approach by also considering the relations that were considered in the above exemplary human analysis. Thus, in the present disclosure not only do the words need to be digitized, but so do the relations between words.

One aspect of the present disclosure provides a method for performing a machine learning task involving a first category and a second category. The method comprises, at a computer system comprising at least one processor and a memory storing at least one program for execution by the at least one processor, the at least one program comprising instructions for obtaining a first plurality of object embeddings for a first dataset. The first dataset comprises a first plurality of objects of a first category. Each respective object embedding in the first plurality of object embeddings is a respective vector representing a plurality of properties of a different object in the first plurality of objects within a first concurrence scope.

The first plurality of object embeddings is used to determine a first plurality of morphism embeddings for a first plurality of morphisms for the first dataset. Each respective morphism embedding in the first plurality of morphism embeddings represents a morphism in the first plurality of morphisms between a respective first and second object in the first plurality of objects in the form of a corresponding matrix. The corresponding matrix, when multiplied by the object embedding of the respective first object in the first plurality of object embeddings, realizes with a first threshold probability the object embedding of the respective second object in the first plurality of object embeddings.

The at least one program further comprises instructions for obtaining a second plurality of object embeddings for a second dataset. The second dataset comprises a second plurality of objects of a second category. Each respective object embedding in the second plurality of object embeddings is a respective vector representing a plurality of properties of a different object in the second plurality of objects within the first concurrence scope.

The at least one program further comprises instructions for using the second plurality of object embeddings to determine a second plurality of morphism embeddings for a second plurality of morphisms for the second dataset. Each respective morphism embedding in the second plurality of morphism embeddings represents a morphism in the second plurality of morphisms between a respective first and second object in the second plurality of objects in the form of a corresponding matrix. The corresponding matrix, when multiplied by the object embedding of the respective first object in the second plurality of object embeddings, realizes with a second threshold probability the object embedding of the respective second object in the second plurality of object embeddings.

The at least one program further comprises instructions for refining a first functor between the first category and the second category by optimizing a weighted combination of (i) a universal structure loss over each corresponding pair of morphism embeddings in the first and second plurality of morphism embeddings and (ii) an alignment loss over a subset of supervised object embeddings taken from the first and second plurality of object embeddings.

The at least one program further comprises instructions for using the first functor to equate a query object in the first category to a target object in the second category thereby performing a machine learning task (e.g., a translation between one or more objects in the first category to one or more corresponding objects in the second category) between a first dataset to a second dataset.

In some embodiments, each object in the first dataset is a corresponding set of one or more related images and each object in the second dataset is a word or a phrase. In some embodiments, each object in the first dataset is a word or phrase in a first language, each object in the second dataset is a word or phrase in a second language, the first dataset comprises a first plurality of documents written in the first language, and the second dataset comprises a second plurality of documents written in the first language.

In some embodiments, the universal structure loss over each corresponding pair of morphism embeddings in the first and second plurality of morphism embeddings, [symbol] _{struc}, has the form:

[symbol]

_{struc}=Σ_{f}∥ [symbol] − [symbol] M_{f}∥²,

where f is a morphism in the first plurality of morphisms, M_{f} is a morphism embedding in the first plurality of morphism embeddings, [symbol] is the morphism in the second plurality of morphism embeddings corresponding to M_{f}, and [symbol] is the first functor. In some such embodiments, the alignment loss over the subset of corresponding object embeddings in the first and second plurality of object embeddings has the form:

[symbol]

_{align}= [symbol] ∥ [symbol] − [symbol] vₐ∥²,

where a is an object in the first plurality of objects, [symbol] is the first plurality of objects, vₐ is an object embedding in the first plurality of object embeddings that represents a, [symbol] is an object embedding in the second plurality of object embeddings that represents the object in the second plurality of object embeddings that corresponds to a, [symbol] is the first functor.

In some embodiments, the subset of supervised object embeddings taken from the first and second plurality of object embeddings represents less than fifty percent, less than forty percent, less than thirty percent, less than twenty percent, less than ten percent, less than five percent, less than one percent, or less than 0.1 percent of the object embeddings in the first and second plurality of object embeddings.

In some embodiments the method further comprises, prior to the refining the first functor, forming the subset of supervised object embeddings by labeling less than fifty percent, less than forty percent, less than thirty percent, less than twenty percent, less than ten percent, less than five percent, less than one percent, or less than 0.1 percent of the object embeddings in the second plurality of object embeddings using terms associated with the first category.

In some embodiments the method further comprises, prior to the refining E), forming the subset of supervised object embeddings by labeling less than thirty percent of the objects in the second plurality of object embeddings using terms associated with the first category.

In some embodiments, a respective morphism embedding in the first plurality of morphism embeddings representing a morphism between a respective first object a and a respective second object b in the first plurality of objects is determined by refining a loss function that includes a linking probability between a and b and an unlinking probability for a set of pairs (a, b′), where each respective b′ in the set of pairs is an object in the first plurality of objects that is not identified as linked with a. In some such embodiments, the loss function [symbol] has the form

$$ℒ = {𝔼}_{( a , b ) ∼ p ( a , b )} ( log P ( a \to b ) ) + {𝔼}_{( a ) ∼ p ( a )} ( {𝔼}_{{b}^{′} ∼ {p}_{N} ( {b}^{′} )} ( log ( 1 - P ( a \to {b}^{′} ) ) ) ) , \\ wherein , \\ P ( a \to b ) = sigmoid ( z ( a \to b ) ) ≡ \frac{{e}^{z ( a \to b )}}{1 + {e}^{z ( a \to b )}} , \\ z ( a \to b ) = {agg}_{f} z ( a {\to }^{f} b ) , \\ z ( a {\to }^{f} b ) = {v}_{b}^{T} {M}_{f} {v}_{a} ,$$

M_{f} is a respective morphism embedding representing the morphism f between a and b, vₐ is the object embedding of a in the first plurality of object embeddings, v_{b}^{T} is a transpose of the object embedding of b in the first plurality of object embeddings,

$$z ( a {\to }^{f} b )$$

is a score function that evaluates the respective morphism f between a and b, given by v_{b}^{T}M_{f}vₐ, or by a neural network that takes M_{f}, vₐ, and v_{b} as input and returns a scalar score,

$${agg}_{f} z ( a {\to }^{f} b )$$

is an aggregation of the score for the morphism f between a and b into a final score z(a→b), z(a→b) is a logit that determines P(a→b), P(a→b) is a linking probability that a and b are related by one or more morphisms, 1−P(a→b′) is an unlinking probability describing a probability that a and b are not related by one or more morphisms,

$${𝔼}_{( a , b ) ∼ p ( a , b )} ( log P ( a \to b ) )$$

is expectation of the log likelihood of the linking probability given (a, b)˜p(a, b), (a, b)˜p(a, b) is a sampling distribution across pairs of objects in the first concurrence scope drawn from the first dataset,

$${𝔼}_{( a ) ∼ p ( a )} ( {𝔼}_{{b}^{′} ∼ {p}_{N} ( {b}^{′} )} ( log ( 1 - P ( a \to {b}^{′} ) ) ) )$$

is the expectation of the log likelihood of the unlinking probability given (a)˜p(a), and b′˜p_{N}(b′), a˜p (a) is a marginal distribution of a across objects drawn from the first dataset, and b′˜p_{N}(b′) is a negative sampling distribution of b′ across objects drawn from the first dataset.

In some embodiments, p(a)=Σ_{b}p(a, b) and is a marginalization of the joint distribution p(a, b) of concurrence probability, and p_{N}(b′) can either be taken as the marginal distribution or a fractional power p_{N}(b′)^{k} of the marginal distribution.

In some embodiments, the loss function is optimized by gradient decent or gradient ascent.

In some embodiments, the refining the loss function comprises encoding each matrix value for M_{f} as a corresponding hidden weight in a neural network that is configured to solve for v_{b}^{T}M_{f}vₐ upon inputting vₐ and v_{b} into the neural network and using the output of the neural network upon inputting vₐ and v_{b} to refine each matrix value for M_{f} in accordance with the loss function.

In some embodiments, the first plurality of objects comprises more than fifty objects, the first plurality of object embeddings comprises more than fifty object embeddings, and the first plurality of morphism embeddings comprises more than fifty morphism embeddings.

In some embodiments, the method further comprises determining a linking probability P(a→b) between a first object a and a second object b in first plurality of objects and adding a corresponding composite object v_{a\textcircled{×}b} to the first plurality of objects when the linking probability P(a→b) exceeds a threshold value. In some such embodiments the corresponding composite object v_{a\textcircled{×}b} is calculated as a tensor bifunctor

v_{a\textcircled{×}b}=Φ(vₐ\textcircled{×}v_{b}),

where vₐ\textcircled{×}v_{b} is implemented as a Kronecker product and Φ is a projection matrix that maps vₐ\textcircled{×}v_{b} to v_{a\textcircled{×}b} linearly, or a neural network that maps vₐ\textcircled{×}v_{b} to v_{a\textcircled{×}b} non-linearly.

In some embodiments, the first plurality of objects comprises a plurality of elemental objects and a plurality of composite objects, and the method further comprises tracking, for each respective composite object in the plurality of composite objects, a number of elemental objects used to form the respective composite object.

In some embodiments, the method further comprises obtaining a third plurality of object embeddings for the first dataset, where each respective object embedding in the third plurality of object embeddings is a respective vector representing a plurality of properties of a different object in the first plurality of objects within a second concurrence scope, the second concurrence scope is different from the first concurrence scope, a respective morphism embedding in the first plurality of morphism embeddings representing a morphism between a respective first object a and a respective second object b in the first concurrence scope in the first plurality of objects is determined by refining a first loss function that includes a linking probability between a and b, P(a→b), and an unlinking probability for a first set of pairs (a, b′), where each b′ in the first set of pairs is an object in the first plurality of objects in the first concurrence scope that is not identified as linked with a, and a respective morphism embedding in the first plurality of morphism embeddings representing a morphism between a respective first object c and a respective second object din the second concurrence scope in the first plurality of objects is determined by refining a second loss function that includes a linking probability between c and d, P(c→d), and an unlinking probability for a second set of pairs (c, d′), where each d′ in the second set of pairs is an object in the second plurality of objects in the second concurrence scope that is not identified as linked with c.

In some embodiments, each object embedding in the first plurality of object embeddings is obtained using a skip-gram method, a common bag of words method, or a skip-gram negative sampling method.

Another aspect of the present disclosure provides a method for performing a machine learning task involving a first category and a second category. The method comprises obtaining a first plurality of object embeddings for a first dataset, where the first dataset comprises a first plurality of objects of a first category, and where each respective object embedding represents a plurality of properties of a different object in the first plurality of objects. The first plurality of object embeddings is used to determine a first plurality of morphism embeddings for a first plurality of morphisms for the first dataset. Each respective morphism embedding in the first plurality of morphism embeddings represents a morphism in the first plurality of morphisms between a respective first and second object in the first plurality of objects. The respective morphism, when applied to the object embedding of the respective first object in the first plurality of object embeddings, realizes with a first threshold probability the object embedding of the respective second object in the first plurality of object embeddings. The method further comprises obtaining a second plurality of object embeddings for a second dataset, where the second dataset comprises a second plurality of objects of a second category, and where each respective object embedding represents a plurality of properties of a different object in the second plurality of objects. The method further comprises using the second plurality of object embeddings to determine a second plurality of morphism embeddings for a second plurality of morphisms for the second dataset, where each respective morphism embedding in the second plurality of morphism embeddings represents a morphism in the second plurality of morphisms between a respective first and second object in the second plurality of objects, where the respective morphism, when applied to the object embedding of the respective second object in the second plurality of object embeddings, realizes with a second threshold probability the object embedding of the respective second object in the second plurality of object embeddings. The method further comprises refining a first functor between the first category and the second category by optimizing at least a universal structure loss over each corresponding pair of morphism embeddings in the first and second plurality of morphism embeddings. The method further comprises using the first functor to equate a query object in the first category to a target object in the second category thereby performing a machine learning task between a first dataset to a second dataset.

Another aspect of the present disclosure provides a method for performing a machine learning task involving a first category. The method comprises obtaining a first plurality of object embeddings for a first dataset, where the first dataset comprises a first plurality of objects of the first category, and where each respective object embedding in the first plurality of object embeddings is a respective vector representing a plurality of properties of a different object in the first plurality of objects within a first concurrence scope. The first plurality of object embeddings is used to determine a first plurality of morphism embeddings for a first plurality of morphisms for the first dataset. Each respective morphism embedding in the first plurality of morphism embeddings represents a morphism in the first plurality of morphisms between a respective first and second object in the first plurality of objects in the form of a corresponding matrix, where the corresponding matrix, when multiplied by the object embedding of the respective first object in the first plurality of object embeddings, realizes with a first threshold probability the object embedding of the respective second object in the first plurality of object embeddings. The method further comprises determining a plurality of linking probabilities, each respective linking probability in the plurality of linking properties, P(a→b), between a corresponding first object a and a corresponding second object b in first plurality of objects, using each morphism in the first plurality of morphisms between the corresponding first object a and the corresponding second object b. The method further comprises adding a corresponding composite object v_{a\textcircled{×}b} to the first plurality of objects for each respective pair of objects (a, b) in the first plurality of objects when the linking probability P(a→b) between the respective pair of objects exceeds a threshold value, thereby adding a plurality of composite objects to the first plurality of objects. The method further comprises receiving a search query comprising a second plurality of objects in the first category and using the first plurality of objects to identify a match to the search query.

In some embodiments, the corresponding composite object v_{a\textcircled{×}b} is calculated as a tensor bifunctor

v_{a\textcircled{×}b}=Φ(vₐ\textcircled{×}v_{b}),

where, vₐ\textcircled{×}v_{b} is implemented as a Kronecker product, and Φ is a projection matrix that maps vₐ\textcircled{×} v_{b} to v_{a\textcircled{×}b} linearly, or a neural network that maps vₐ\textcircled{×}v_{b} to v_{a\textcircled{×}b} non-linearly.

In some embodiments, using the first plurality of object embeddings to determine a first plurality of morphism embeddings for a first plurality of morphisms for the first dataset, the determining a plurality of linking probabilities, and the adding a corresponding composite object v_{a\textcircled{×}b} to the first plurality of objects is repeated until a repetition criterion is achieved. In some such embodiments, the repetition criterion is a failure to identify any additional objects in the first plurality of objects that has a linking probability that exceeds the threshold value. In some embodiments, the repetition criterion is simply repeating the process a number of times (e.g., twice, three times, four times, etc.).

In some embodiments, the machine learning task is natural language processing.

In some embodiments, each object in the first dataset is a word or phrase in a first language, and the first dataset comprises a first plurality of documents written in the first language.

In some embodiments, a respective morphism embedding in the first plurality of morphism embeddings representing a morphism between a respective first object a and a respective second object b in the first plurality of objects is determined by refining a loss function that includes a linking probability between a and b, P(a→b), and an unlinking probability for a set of pairs (a, b′), where each respective b′ in the set of pairs is an object in the first plurality of objects. In some such embodiments, the loss function [symbol] has the form

$$ℒ = {𝔼}_{( a , b ) ∼ p ( a , b )} ( log P ( a \to b ) ) + {𝔼}_{( a ) ∼ p ( a )} ( {𝔼}_{{b}^{′} ∼ {p}_{N} ( {b}^{′} )} ( log ( 1 - P ( a \to {b}^{′} ) ) ) ) , \\ wherein , \\ P ( a \to b ) = sigmoid ( z ( a \to b ) ) ≡ \frac{{e}^{z ( a \to b )}}{1 + {e}^{z ( a \to b )}} , \\ z ( a \to b ) = {agg}_{f} z ( a {\to }^{f} b ) , \\ z ( a {\to }^{f} b ) = {v}_{b}^{T} {M}_{f} {v}_{a} ,$$

M_{f} is a respective morphism embedding representing the morphism f between a and b, vₐ is the object embedding of a in the first plurality of object embeddings, v_{b}^{T} is a transpose of the object embedding of b in the first plurality of object embeddings,

$$z ( a {\to }^{f} b )$$

is a score function that evaluates the respective morphism f between a and b, given by v_{b}^{T}M_{f}vₐ, or by a neural network that takes M_{f}, vₐ, and v_{b} as input and returns a scalar score,

$${agg}_{f} z ( a {\to }^{f} b )$$

is an aggregation of the score for the morphism f between a and b into a final score z(a→b), z(a→b) is a logit that determines P(a→b), P(a→b) is a linking probability that a and b are related by one or more morphisms, 1−P(a→b′) is an unlinking probability describing a probability that a and b are not related by one or more morphisms,

$${𝔼}_{( a , b ) ∼ p ( a , b )} ( log P ( a \to b ) )$$

is expectation of the log likelihood of the linking probability given (a, b)˜p(a, b), (a, b)˜p(a, b) is a sampling distribution across pairs of objects in the first concurrence scope drawn from the first dataset,

$${𝔼}_{( a ) ∼ p ( a )} ( {𝔼}_{{b}^{′} ∼ {p}_{N} ( {b}^{′} )} ( log ( 1 - P ( a \to {b}^{′} ) ) ) )$$

is the expectation of the log likelihood of the unlinking probability given (a)˜p(a), and b′˜p_{N}(b′), a˜p (a) is a marginal distribution of a across objects drawn from the first dataset, and b′˜p_{N}(b′) is a negative sampling distribution of b′ across objects drawn from the first dataset.

In some embodiments p(a)=Σ_{b}p(a, b) and is a marginalization of the joint distribution p(a, b) of concurrence probability, and p_{N}(b′) can either be taken as the marginal distribution or a fractional power p_{N}(b′)^{k} of the marginal distribution.

In some embodiments, the loss function is optimized by gradient decent or gradient ascent.

In some embodiments, refining the loss function comprises encoding each matrix value for M_{f} as a corresponding hidden weight in a neural network that is configured to solve for v_{b}^{T}M_{f}vₐ upon inputting vₐ and v_{b} into the neural network and using the output of the neural network upon inputting vₐ and v_{b} to refine each matrix value for M_{f} in accordance with the loss function.

In some embodiments, the first plurality of objects comprises more than fifty objects, the first plurality of object embeddings comprises more than fifty object embeddings, and the first plurality of morphism embeddings comprises more than fifty morphism embeddings.

In some embodiments, the method further comprises obtaining a second plurality of object embeddings for the first dataset, where each respective object embedding in the second plurality of object embeddings is a respective vector representing a plurality of properties of a different object in the first plurality of objects within a second concurrence scope, and the second concurrence scope is different from the first concurrence scope. Moreover, a respective morphism embedding in the first plurality of morphism embeddings representing a morphism between a respective first object a and a respective second object b within the first concurrence scope in the first plurality of objects is determined by refining a first loss function that includes a linking probability between a and b, P (a→b), and an unlinking probability for a first set of pairs (a, b′), where each b′ in the first set of pairs is an object in the first plurality of objects in the first concurrence scope that is not identified as linked with a, and a respective morphism embedding in the first plurality of morphism embeddings representing a morphism between a respective first object c and a respective second object d within the second concurrence scope in the first plurality of objects is determined by refining a second loss function that includes a linking probability between c and d, P(c→d), and an unlinking probability for a second set of pairs (c, d′), where each d′ in the second set of pairs is an object in the second plurality of objects in the second concurrence scope that is not identified as linked with c.

In some embodiments, prior to the adding a corresponding composite object v_{a\textcircled{×}b} to the first plurality of objects for each respective pair of objects (a, b) in the first plurality of objects, the first plurality of objects consists of a plurality of elemental objects, and upon achievement of the above-described repetition criterion, the first plurality of objects comprises: a first subset of composite objects, where each composite object in the first subset of composite objects is a composite of a first number of elemental objects in the plurality of elemental objects, a second subset of composite objects, where each composite object in the second subset of composite objects is a composite of a second number of elemental objects in the plurality of elemental objects, and a third subset of composite objects, where each composite object in the third subset of composite objects is a composite of a third number of elemental objects in the plurality of elemental objects, where the first number is greater than the second number and the second number is greater than the third number.

In some embodiments, the method further comprises tracking, for each respective composite object in the plurality of composite objects, a number of elemental objects used to form the respective composite object.

In some embodiments, the first plurality of objects to identify a match to the search query comprises (i) combing the second plurality of elemental objects for a match between a composite object in the first subset of composite objects and the second plurality of objects, (ii) combing, after the combing (i), the second plurality of objects for a match between a composite object in the second subset of composite objects and the second plurality of objects, (iii) combing, after the combing (ii), the second plurality of objects for a match between a composite object in the third subset of composite objects and the second plurality of objects; (iv) optionally combing, after the combing (iii), the second plurality of objects for a match between a non-composite object in the second plurality of objects and the plurality of elemental objects; and (v) using each match from the combing (i), the combing (ii), the combing (iii), and optionally the combing (iv) to identify a document in a plurality of documents for the search query string, where the plurality of documents are in the first category.

In some embodiments, the using the first plurality of objects to identify a match to the search query comprises: (i) combing the second plurality of elemental objects for a match between a composite object in the first subset of composite objects and the second plurality of objects, (ii) combing, after the combing (i), the second plurality of objects for a match between a composite object in the second subset of composite objects and the second plurality of objects, (iii) combing, after the combing (ii), the second plurality of objects for a match between a composite object in the third subset of composite objects and the second plurality of objects; (iv) optionally combing, after the combing (iii), the second plurality of objects for a match between a non-composite object in the second plurality of objects and the plurality of elemental objects; and (v) using each match from the combing (i), the combing (ii), the combing (iii), and optionally the combing (iv) to identify a match between a non-composite object in the second plurality of objects and the plurality of elemental objects; and (vi) using each match from the combing (ii), the combing (iii), the combing (iv), and optionally the combing (v) to identify an image in a plurality of images for the search query string, where the plurality of images are in the first category.

As an example, in some embodiments, the first number is 4, the second number is 3, and the third number is 2.

In some embodiments, each object embedding in the first plurality of object embeddings is obtained using a skip-gram method, a common bag of words method, or a skip-gram negative sampling method.

Another aspect of the present disclosure provides a method for performing a machine learning task involving a first category. The method comprises obtaining a first plurality of object embeddings for a first dataset. The first dataset comprises a first plurality of objects of the first category. The method further comprises using the first plurality of object embeddings to determine a first plurality of morphism embeddings for a first plurality of morphisms for the first dataset. Each respective morphism embedding in the first plurality of morphism embeddings represents a morphism in the first plurality of morphisms between a respective first and second object in the first plurality of objects. The respective morphism, when applied to the object embedding of the respective first object in the first plurality of object embeddings, realizes with a first threshold probability the object embedding of the respective second object in the first plurality of object embeddings. The method further comprises determining a plurality of linking probabilities, each respective linking probability in the plurality of linking properties, P(a→b), between a corresponding first object a and a corresponding second object b in first plurality of objects, using each morphism in the first plurality of morphisms between the corresponding first object a and the corresponding second object b. The method further comprises adding a corresponding composite object v_{a\textcircled{×}b} to the first plurality of objects for each respective pair of objects (a, b) in the first plurality of objects when the linking probability P(a→b) between the respective pair of objects exceeds a threshold value, thereby adding a plurality of composite objects to the first plurality of objects. The method further comprises receiving a search query comprising a second plurality of objects in the first category and using the first plurality of objects to identify a match to the search query.

Another aspect of the present disclosure provides computer systems for performing a machine learning task. Such computer systems comprise at least one processor and a memory storing at least one program comprising instructions for execution by the at least one processor. In some embodiments, the at least one program comprises instructions for performing any of the methods and embodiments disclosed herein, and/or any combinations thereof as will be apparent to one skilled in the art. In some embodiments, the at least one program is configured for execution by a computer.

Another aspect of the present disclosure provides a non-transitory computer-readable storage medium having stored thereon program code instructions that, when executed by a processor, cause the processor to perform a machine learning task. In some embodiments, the program code instructions comprise instructions for performing any of the methods and embodiments disclosed herein, and/or any combinations thereof as will be apparent to one skilled in the art. In some embodiments, the program code instructions are configured for execution by a computer.

### INCORPORATION BY REFERENCE

All publications, patents, and patent applications herein are incorporated by reference in their entireties. In the event of a conflict between a term herein and a term in an incorporated reference, the term herein controls.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The implementations disclosed herein are illustrated by way of example, and not by way of limitation, in the figures of the accompanying drawings. Like reference numerals refer to corresponding parts throughout the several views of the drawings.

FIG. 1 is a block diagram illustrating an example of a computing system in accordance with some embodiments of the present disclosure.

FIG. 2 is a block diagram illustrating an example of a method for performing a machine learning task involving a first category and a second category in accordance with some embodiments of the present disclosure.

FIG. 3 provides an illustration of categorical theory in accordance with the prior art.

FIGS. 4A, 4B, 4C, 4D, and 4E illustrate examples of flowcharts of a method for performing a machine learning task involving a first category and a second category, in accordance with some embodiments of the present disclosure.

FIG. 5A, illustrates how a Functor maps every object from a source category [symbol] to a corresponding object in a target category [symbol] , in accordance with some embodiments of the present disclosure.

FIG. 5B illustrates how a Functor maps every morphism from a source category [symbol] to a corresponding morphism in a target category [symbol] , in accordance with some embodiments of the present disclosure.

FIG. 6 illustrates how a tensor bifunctor maps each pair of objects (a, b) to a composite object a\textcircled{×}b and each pair of morphisms (f, g) to a composite morphism f\textcircled{×}g while preserving the morphism relations between objects, in accordance with some embodiments of the present disclosure.

FIG. 7 illustrates a bootstrap approach for multi-scale categorical representation learning in accordance with some embodiments of the present disclosure.

FIG. 8A illustrates a periodic table in accordance with the prior art.

FIG. 8B illustrates embeddings of elements by singular value decomposition of the point-wise mutual information in accordance with the prior art.

FIG. 8C illustrates examples of compounds in English (left panel) matched with examples of compounds in Chinese (right panel).

FIG. 9 illustrates results of a semi supervised translation in accordance with the present disclosure in which, for each English element, the top three Chinese translations are listed, gray lines are selected supervised elements, a row is green if the correct translation is the top candidate, a row is yellow if the correct translation is not the top candidate but appears within top three, and a row is red if the correct translation does not appear even within the top-three candidates.

FIGS. 10A, 10B, 10C, 10D, 10E, 10F, 10G, 10H, 10I, 10J, 10K, 10L, 10M, 10N, 10O, 10P, 10Q, 10R, 10S, 10T, 10U, and 10V illustrate methods of machine learning in accordance with an embodiment of the present disclosure.

### DETAILED DESCRIPTION

The present disclosure provides technical details mathematical approaches to digitizing not only the objects (e.g. words) in a corpus or other form of collection of objects, such as images, (first dataset) but also the relations between objects. This approach provides a significant advancement over prior art conventional object-oriented approaches. Moreover, in some embodiments of the present disclosure, a hierarchical approach is taken in the sense that, if everything is based on the relations that objects (e.g., words) have, the whole category (e.g., language) will become some form of a hierarchical structure. In mathematics, this is called a stratified space. So, for instance, in the case where the category is documents written in a first language, the language is organized into a hierarchical structure.

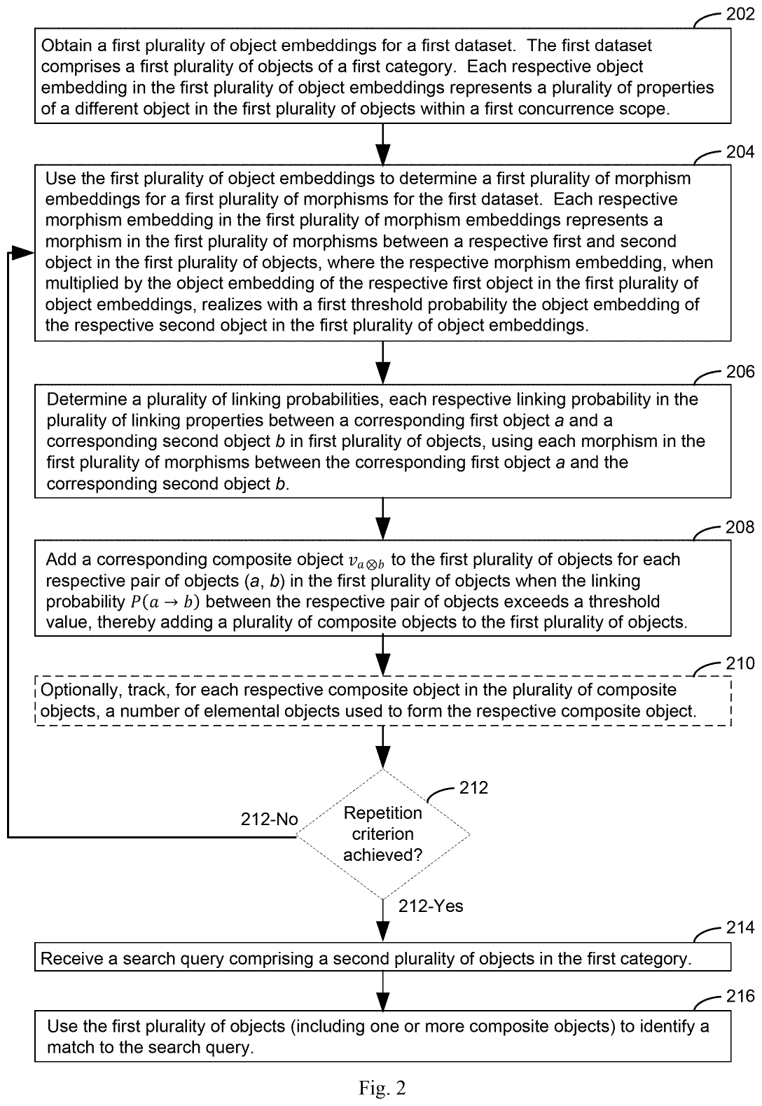

With reference to FIG. 2, at block 202, a first plurality of object embeddings for a first dataset is obtained. The first dataset comprises a first plurality of objects of a first category. Each respective object embedding in the first plurality of object embeddings represents a plurality of properties of a different object in the first plurality of objects within a first concurrence scope. For instance, one such object may be the word “shoe.” In some embodiments, a word2vec algorithm is used to perform this task.

Next, with reference to FIG. 2, at block 204, the first plurality of object embeddings is used to determine a first plurality of morphism embeddings for a first plurality of morphisms for the first dataset. Each respective morphism embedding in the first plurality of morphism embeddings represents a morphism in the first plurality of morphisms between a respective first and second object in the first plurality of objects, where the respective morphism embedding, when multiplied by the object embedding of the respective first object in the first plurality of object embeddings, realizes with a first threshold probability the object embedding of the respective second object in the first plurality of object embeddings.

Next, with reference to FIG. 2, at block 206, a plurality of linking probabilities is determined. Each respective linking probability in the plurality of linking properties is between a corresponding first object a and a corresponding second object b in first plurality of objects, using each morphism in the first plurality of morphisms between the corresponding first object a and the corresponding second object b.

Next, with reference to FIG. 2, at block 208, a corresponding composite object v_{a\textcircled{×}b} is added to the first plurality of objects for each respective pair of objects (a, b) in the first plurality of objects when the linking probability P(a→b) between the respective pair of objects exceeds a threshold value, thereby adding a plurality of composite objects to the first plurality of objects. With reference to block 210, in some embodiments, for each respective composite object in the plurality of composite objects, a number of elemental objects used to form the respective composite object is tracked.

The process of using the first plurality of object embeddings to determine a first plurality of morphism embeddings 204, determining a plurality of linking probabilities 206, and adding composite objects v_{a\textcircled{×}b} to the first plurality of objects 208 is repeated until a repetition criterion is achieved. In this way, the discloses systems turns the original first database into a hierarchical structure, or stratified space, which can be analogized to an apartment complex. An apartment complex is made of rooms, the rooms are organized into hallways, hallways are inside floors (levels), and the floors are stacked on top of each other and, essentially, by looking at this and you can arrive at a very compound structure that is the apartment complex. Looking at relations between objects (e.g., words) in the first database allows for the construction of a digitized mathematical space that the algorithm running on a computer can understand and this digitized space has a hierarchical structure. For instance, its single bricks that make it are the objects (e.g., words) that are used in a particular category (e.g., the English language literature, or any particular language literature). Then, to make walls and floors and roofs and so on, relations between the objects (e.g., words) are examined, and from objects that are related to each other compound words are formed in accordance with block 208 of FIG. 2: two object compound objects, three object compound objects, four object compound objects, and so forth. So every time an object in the first database is selected, it can have all possible relations with the rest of the objects in the first category (e.g., language). For instance, for even a single given word two word compound phrases can be identified that include the given word, three word compound phrases that include the given word, and so forth. So the approach taken in the present disclosure is look at the relations and, as soon as two objects are determined to be related to each other (in block 206), they are made into a compound object (in accordance with block 208). But the referenced hierarchy goes further beyond this. Because, relations between compound objects can be elucidated exactly like in the building analogy. In the building, every brick is related to the brick next to it. Every brick is related to the brick on the top of it and these relationships make a compound set of bricks which are the walls. But the walls are also related to each other by walls. And the walls make rooms and adjacent rooms are related to each other. This evidences a hierarchical structure, a form of nesting of relations that can be constructed.

Drawing on the above analogy, in the present disclosure, relations within a category of objects are digitized. Then, from the relations, if the two objects (e.g., words) are related to each other (block 208), a two-object compound object is made. Such two-object compound object are analogous to the walls in the above analogy. Once two-object compounds objects are formed, relations between two-compound objects or between two-compound objects and single objects can be identified, and three-object (e.g., hallways) and four-object compound (e.g., floors) objects formed in further instance of block 208 upon repetition in accordance with block 212-No. This hierarchical approach can continue until no further relationship are found. The complexity of the most complex objects in this approach will depend on the category under analysis. Some categories will have only two or three levels of complexity (two or three-object complex objects), while other categories will have four or more, five or more, six or more 10 or more or even 100 or more layers of complexity.

The disclosed approach has profound capability over conventional approaches. What is conventionally used in natural language processing is a word based approach. Given a training set (e.g., a corpus of training documents) with numerous relationships, conventional algorithms parse these documents by using a complex graph with nodes and edges, where each edge represents a relationship. Such graphs for most applications end up being very complex because of the large number of relationships in the objects in the document. The present disclosure does not take this approach. The objects in the category (e.g., corpus of documents) are combed, as you comb your hair, looking for a structure. In some sense, it is like you take a picture of the people in the world, it is a complex image. But the present disclosure, like humans, does not look at the problem of digitizing the image this way. In the present approach, the people are analyzed for relationships: here is Arton, he is sitting in Harvard square, Harvard is in Boston, Boston is in America; here is Yizhuang, he came from Beijing, Beijing is in China. As soon as structure is elucidated, it is easier to classify and compile information. The proposed approach improves natural language processing because it provides a way of mapping relations to mathematical objects. In conventional approaches, object (e.g., words) are mapped to mathematical objects. But with the disclosed approach, relations between words are mapped to mathematical objects, and relations between relations are also being mapped to mapped to mathematical objects. This improves the performance of machine learning approaches.

Not only that, the hierarchy, which is just intrinsic to this very construction allows an algorithm to fuse elementary objects (e.g., words) together into compound objects, and look at relationships between fused objects, or between fused objects and elementary objects, and map these relationships also to mathematical objects. This will provide improved machine learning approaches.

For example, consider analysis of a Shakespeare book using the disclosed approach, in which an algorithm uses the Shakespeare book to identify relations: phrases in relation to the other phrases, sentences, paragraphs, and so forth. Then, consider the case where a phrase is presented to the trained algorithm, where the phrase exactly matches a compound object identified through analysis of the Shakespeare book. That is, the trained algorithm has already learned about the compound object and understands the phrase as a fusion of words and the relationships between words. Thus, the trained algorithm already understands the input presented phrase as a single block. In this instance, it is much easier to do a search as a fusion of words and the relations between words. For instance, it is much easier if the input phrase is parsed as “Tom is living in a building in San Francisco” rather than the conventional mapping of Brett is living between George and Sarah and Sarah is living near Henry. The conventional approach in which each person in almost 7 billion people is a node in a complex graph, is much more difficult than an approach in which people are digitized in compound form, such as the city, state and/or country you live in. It is much easier to find the compound object of Henry living in San Francisco which is in California, then Henry by himself. It is the same thing with natural language processing, the disclosed approach uses this technology to produce mathematical objects for compound words, relations between words, relations between compound words and so forth.

Now, imagine that you have a sentence and you are trying to match it with an image, each in accordance with blocks 214 and 216 of FIG. 2. In conventional approaches, the natural language processing algorithm considers the sentence as a collection of vectors, each vector associated with a different single word in a sentence (e.g., in accordance with block 202 of FIG. 2). The trained algorithm then tries to align the collection of word vectors with another set of vectors that represent images to determine if there is an alignment, which is difficult. In the disclosed approach, by contrast, the same sentence will be represented by much fewer vectors, because there is a high probability that some of the words in the sentence will be recognized as compound objects. Thus, the same sentence in the present approach can be represented by fewer vectors. That is, in the present approach understands words as vectors, but also understands relations between words, as soon as there is a relation, it can make compound words, the compound words are mapped to more compound phrases, and, in fact, it could be that the entire sentence is associated with one mathematical object. In such an instance, rather than having to map all the words as individual vectors to a mathematical representation of an image, it just needs to map the single mathematical object for the entire sentence to a mathematical representation of an image, which is much easier to do. This can be analogized to a database having each person in the universe, and trying to find within this data John with a certain zip code (a compound object) as supported in the disclosed approach, as opposed a conventional graph in which one needs to find John as a node in a very complex graph (John is a person who lives in between George and Beth). The conventional graph is much harder to work with because the people in the conventional approach have not been giving any kind of hierarchy or any kind of ranking between them. John could as well be located in China, because there are such people in China with the name John. It is very hard to find where John is in the conventional approach. But if John is now fused with the zip code where John is located based on how John is related to Earth: John is living in the United States, John is living in California, California comprises a collection of cities, John is living in a particular city.

The disclosed approaches require more effort to train but, once trained, improves machine learning tasks, such as natural language processing, and alleviates the reliance on millions of terabytes of data by conventional approaches to achieve satisfactory performance. Moreover, the disclosed approaches make alignment much easier and less data intensive.

Moreover, the disclosed approach can digitize completely language as a space with hierarchical structure. The hierarchy is given by the way of words and more compound words and so forth that are related to each other. The disclosed approach can also do this when translating between categories. In fact, relations are used in the disclosed approach to guess what the meaning of the words are in other languages. This is like imagining an alien has just arrived from mars with a document written in Chinese. There is no preconceived notion as to what the Chinese words are (e.g., some love the story, etc.). But now consider a semi-supervised learning approach in which someone now identifies a few of the words in the documents as being certain chemical elements. For instance, one of the characters in the Chinese document is identified as meaning hydrogen, another character in the Chinese document is identified as meaning oxygen, another character in the Chinese document is identified as meaning fluoride. With this information in hand, the systems and methods of the present disclosure can scan through the document looking for similarities, how the identified characters are related to other unknown pictures (characters) in the Chinese document. Moreover, the systems and methods of the present disclosure can similarly scan the English category and learn relationships that involve oxygen. For instance, the algorithm may discover that when oxygen is present, so is carbon and the subscript 2, e.g., as in CO₂. Thus, the algorithm learns a relationship between oxygen, carbon and the subscript 2. This relationship from the English category can be used to learn the identity of unknown objects in the second category. For instance, using the known character in Chinese for oxygen, and the known relationship between oxygen, carbon and the subscript 2 from the English category, the pictures (identity) of the characters for carbon and the subscript 2 can be learned. So by looking at relationships, the systems and methods of the present disclosure can translate from one category (e.g., language) to another.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

The implementations described herein provide various technical solutions for performing machine learning tasks such as natural language processing, fulfillment of a search engine, reinforcement learning (e.g., autonomous driving, autonomous flying, robotics, etc.), security and drug discovery.

### Definitions

As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of ±20%, ±10%, ±5%, or ±1% of a given value. The term “about” or “approximately” can mean within an order of magnitude, within 5-fold, or within 2-fold, of a value. Where particular values are described in the application and claims, unless otherwise stated the term “about” meaning within an acceptable error range for the particular value should be assumed. The term “about” can have the meaning as commonly understood by one of ordinary skill in the art. The term “about” can refer to ±10%. The term “about” can refer to ±5%.

The terminology used herein is for the purpose of describing particular cases only and is not intended to be limiting. As used herein, the singular forms “a,” “an” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Several aspects are described below with reference to example applications for illustration. It should be understood that numerous specific details, relationships, and methods are set forth to provide a full understanding of the features described herein. One having ordinary skill in the relevant art, however, will readily recognize that the features described herein can be practiced without one or more of the specific details or with other methods. The features described herein are not limited by the illustrated ordering of acts or events, as some acts can occur in different orders and/or concurrently with other acts or events. Furthermore, not all illustrated acts or events are required to implement a methodology in accordance with the features described herein.

Exemplary System Embodiments.

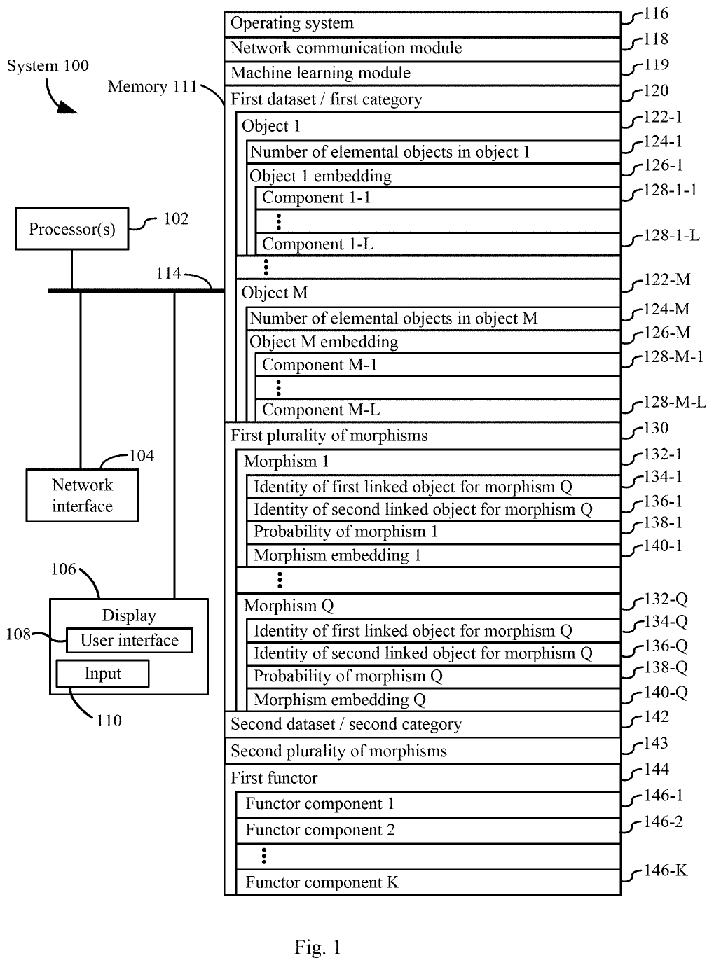

Details of an exemplary system are now described in conjunction with FIG. 1. FIG. 1 is a block diagram illustrating a system 100 in accordance with some implementations. The device 100 in some implementations includes at least one or more processing units CPU(s) 102 (also referred to as processors), one or more network interfaces 104, a display 106 having a user interface 108, an input device 110, a memory 111, and one or more communication buses 114 for interconnecting these components. The one or more communication buses 114 optionally include circuitry (sometimes called a chipset) that interconnects and controls communications between system components. The memory 111 may be a non-persistent memory, a persistent memory, or any combination thereof. The non-persistent memory typically includes high-speed random access memory, such as DRAM, SRAM, DDR RAM, ROM, EEPROM, flash memory, whereas the persistent memory typically includes CD-ROM, digital versatile disks (DVD) or other optical storage, magnetic cassettes, magnetic tape, magnetic disk storage or other magnetic storage devices, magnetic disk storage devices, optical disk storage devices, flash memory devices, or other non-volatile solid-state storage devices. Regardless of its specific implementation, memory 111 comprises at least one non-transitory computer-readable storage medium, and it stores thereon computer-executable executable instructions that can be in the form of programs, modules, and data structures.

In some embodiments, as shown in FIG. 1, the memory 111 stores the following:
an operating system 116, which includes procedures for handling various basic system services and for performing hardware-dependent tasks;
an optional network communication module (or instructions) 118 for connecting the system 100 with other devices and/or to a communication network;
a machine learning module 119;
a first dataset/first category 120 comprising a first plurality of objects 122, and for each respective object in the first plurality of objects, optionally the number of elemental objects 124 in the respective object, and an object embedding 126 for the respective object comprising a plurality of components 128;
a first plurality of morphisms 130, each respective morphism 132 identifying a first linked object 134 in the first dataset and a second linked object 136 in the first dataset, a probability of the respective morphism 138, and associated with a morphism embedding 140 of the respective morphism;
optionally, a second dataset/second category 142 comprising a second plurality of objects, and for each respective object in the plurality of objects, optionally the number of elemental objects in the respective object, and an object embedding for the respective object comprising a plurality of components 128;
optionally, a second plurality of morphisms, each respective morphism identifying a first linked object in the second dataset and a second linked object in the second dataset, a probability of the respective morphism, and a morphism embedding of the respective morphism;
optionally, a first functor 144 between the first category and the second category, the first functor comprising a plurality of functor components 146.

In various implementations, one or more of the above-identified elements are stored in one or more of the previously mentioned memory devices, and correspond to a set of instructions for performing various methods described herein. The above-identified modules, data, or programs (e.g., sets of instructions) need not be implemented as separate software programs, procedures, datasets, or modules, and thus various subsets of these modules and data may be combined or otherwise re-arranged in various implementations. In some implementations, the memory 111 optionally stores a subset of the modules and data structures identified above. Furthermore, in some embodiments, the memory stores additional modules and data structures not described above. In some embodiments, one or more of the above-identified elements is stored in a computer system, other than that of the system 100, that is addressable by the system 100 so that the system 100 may retrieve all or a portion of such data when needed.

Although FIG. 1 depicts a “system 100,” the figure is intended more as a functional description of the various features which may be present in computer systems than as a structural schematic of the implementations described herein. In practice, and as recognized by those of ordinary skill in the art, items shown separately could be combined and some items can be separate. Moreover, although FIG. 1 depicts certain data and modules in the memory 111 (which can be non-persistent or persistent memory), it should be appreciated that these data and modules, or portion(s) thereof, may be stored in more than one memory.

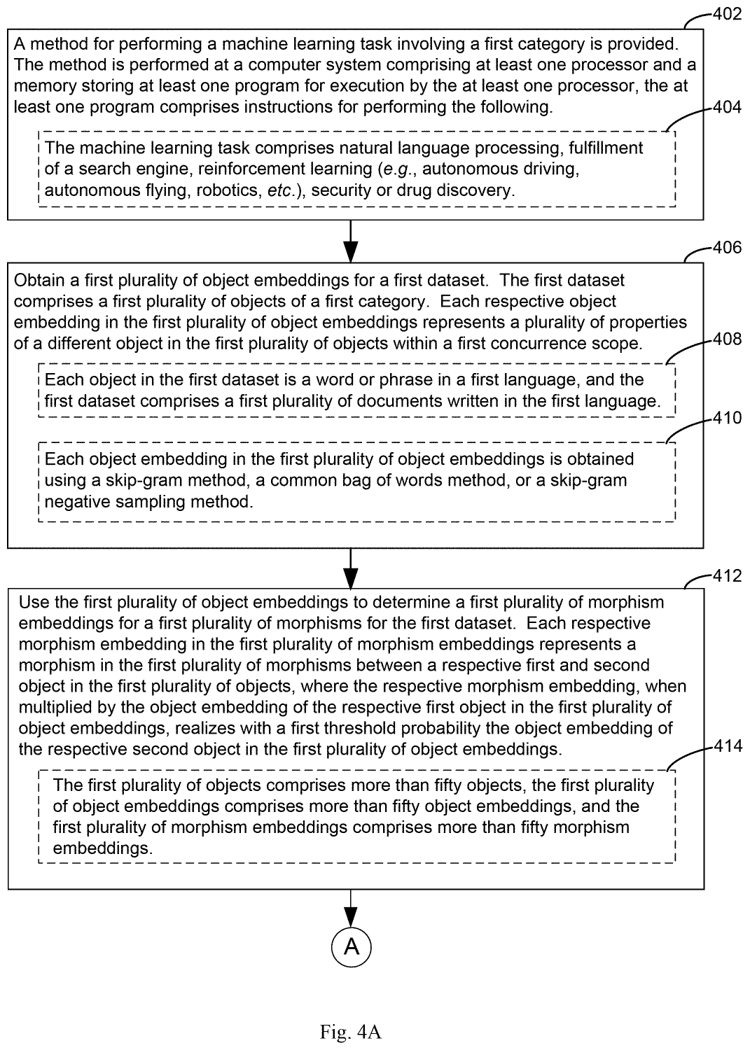

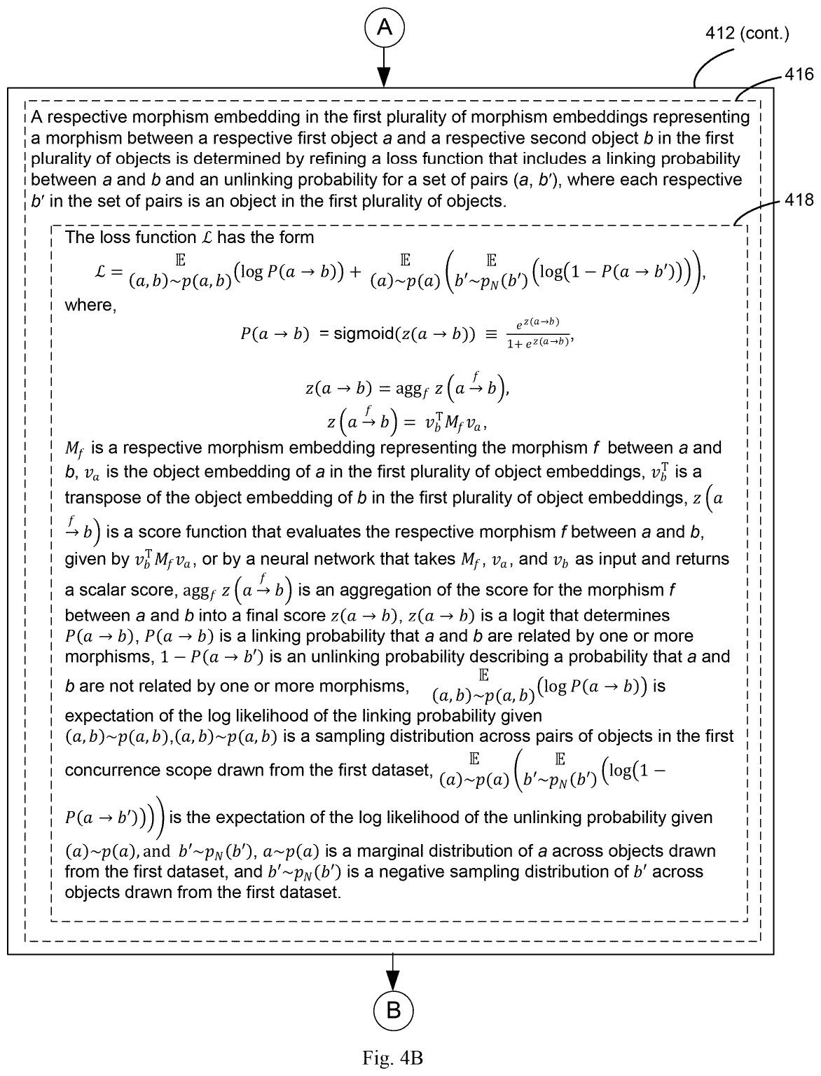

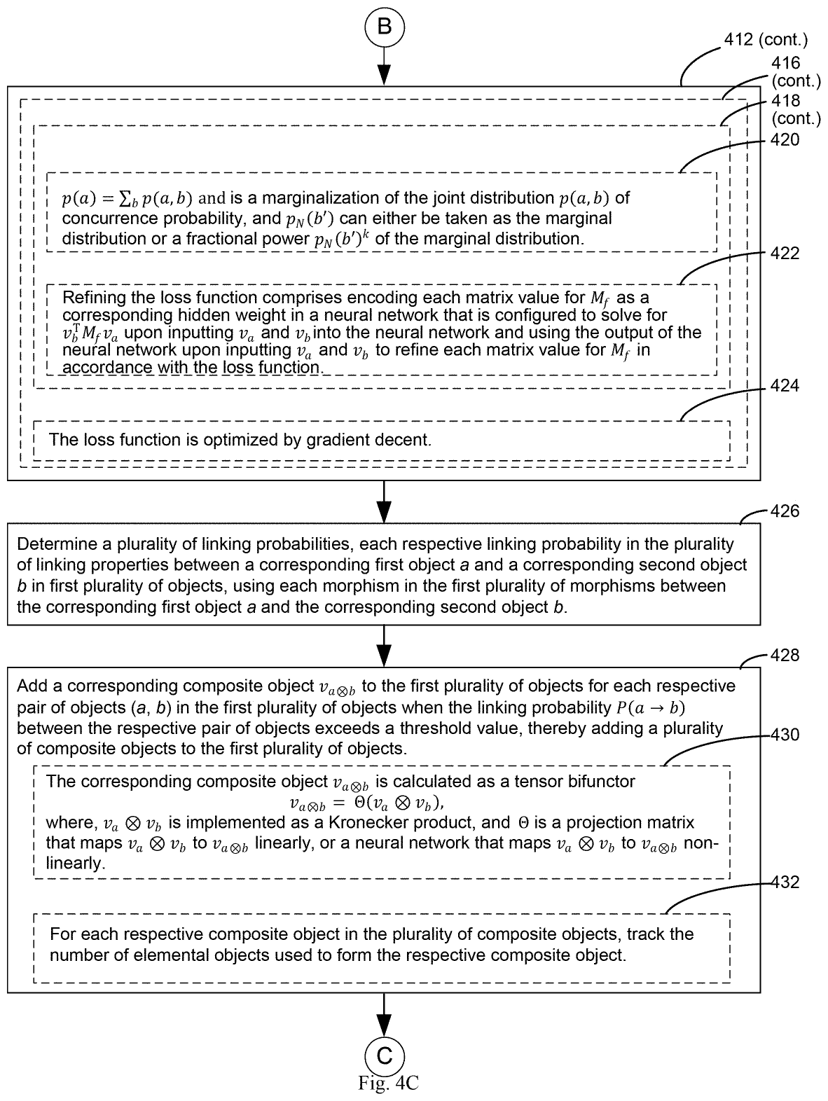

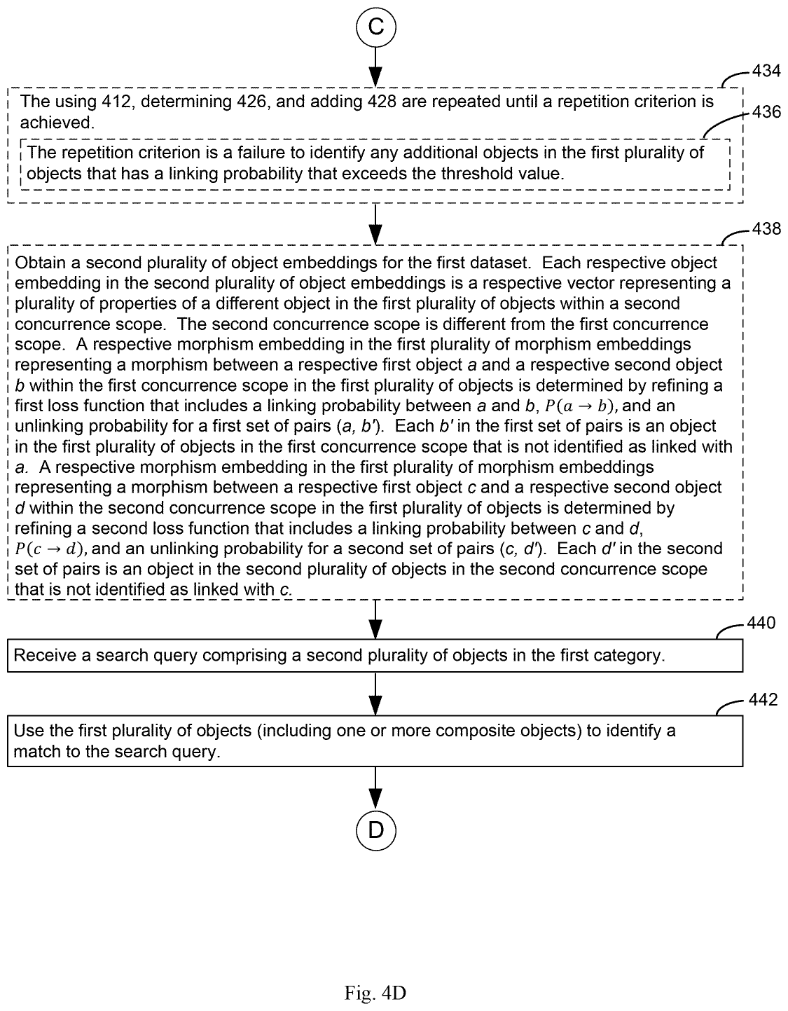

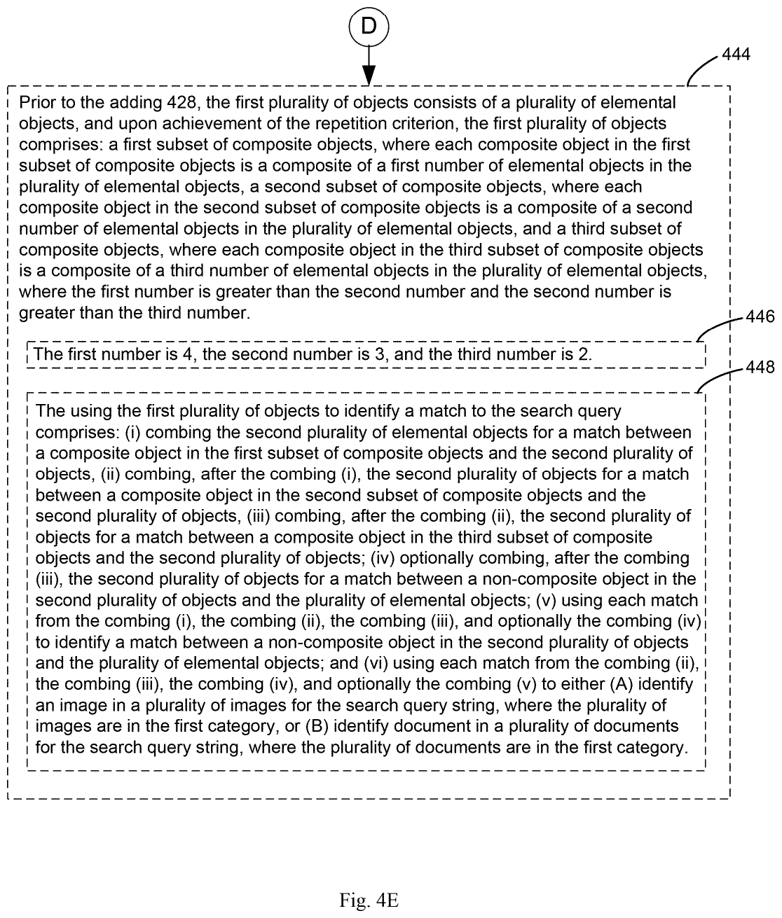

While a system in accordance with the present disclosure has been disclosed with reference to FIG. 1, methods in accordance with the present disclosure are now detailed in conjunction with FIG. 4. FIG. 4 illustrates a block diagram of an example work-flow in accordance with some embodiments of the present disclosure.

Block 402. Referring to block 402 of FIG. 4A, the present disclosure provides a method for performing a machine learning task involving a first category. In some embodiments, the method is performed at a computer system 100 comprising at least one processor 102 and a memory 111 storing at least one program (e.g., machine learning module 119) for execution by the at least one processor. The at least one program comprises instructions for performing the methods disclosed below with reference to FIG. 4.

Block 404. Referring to block 404 of FIG. 4A, in some embodiments the machine learning task comprises natural language processing, fulfillment of a search engine, reinforcement learning (e.g., autonomous driving, autonomous flying, robotics, etc.), security or drug discovery.

Blocks 406-410. With reference to block 406 of FIG. 4A, a first plurality of object embeddings for a first dataset 120 is obtained. The first dataset comprises a first plurality of objects of a first category. In some embodiments, each object 122 in the first plurality of objects is a word and the first category is a particular language, such as English, Chinese, Spanish, Portuguese, Hindi, Arabic, Russian, Japanese, German, Korean, or French, so name a few non-limiting examples. In some embodiments, each object in the first objects is a word and the first category is a programming language, such as C, C++, Fortran, python, etc. In some embodiments each object is a two-dimensional pixelated picture. In some embodiments, each object is a three-dimensional voxelated image (e.g., acquired by computed tomography, magnetic resonant imaging, ultrasound scanning, positron emission tomography) or formed though molecular modeling. For more information on three-dimensional images, see Mankovich, 1990, “Three-Dimensional Image Display in Medicine, Journal of Digital Imaging 3(2), which is hereby incorporated by reference. For more information on the definition of a category, see Section 2.3.1, below.

Each respective object embedding 126 in the first plurality of object embeddings represents a plurality of properties of a different object 122 in the first plurality of objects within a first concurrence scope. In some embodiments, the plurality of properties of an object are properties of the object with the first concurrence scope in the first dataset. For instance, in some embodiments, the first dataset is a corpus of documents and the plurality of properties represented by an object embedding for an object in the first dataset are co-occurrence properties of the word with respect to other words in the first corpus of documents.

In some embodiments, the first plurality of objects are words, and the first concurrence scope is sentences (e.g., occurring in documents in a corpus of documents). In other words, the first concurrent scope is set to sentences. In some embodiments, the first plurality of objects are words and the first concurrence scope is paragraphs (e.g., occurring in documents in a corpus of documents). In some embodiments, the first plurality of objects are words and the first concurrence scope is pages (e.g., occurring in documents in a corpus of documents). In some embodiments, the first plurality of objects are words and the first concurrence scope is chapters (e.g., occurring in documents in a corpus of documents). In some embodiments, the first plurality of objects are words and the first concurrence scope is individual documents (e.g., in a corpus of documents).

With reference to block 408 of FIG. 4A, in some embodiments each object in the first dataset is a word or phrase in a first language, and the first dataset comprises a first plurality of documents written in the first language.

With reference to block 410 of FIG. 4B, in some embodiments each object embedding in the first plurality of object embeddings is obtained using a word2vec method such as a skip-gram algorithm, a continuous bag of words (CBOW) algorithm, or a skip-gram negative sampling method. For more disclosure on non-limiting examples of how to obtain object embeddings for objects using a word2vec method, see chapter 3 (Word2vec—Learning Word Embeddings) and chapter 4 (Advanced Word2vec) of Ganegedra, 2018, Natural Language Processing with Tensorflow, Packt Publishing Ltd. Birmingham, UK, which is hereby incorporated by reference.

In some embodiments, each object embedding is a one-hot encoded representation.

In some embodiments, each object embedding is obtained using a global matrix factorization-based method. A non-limiting example of a global matrix factorization-based method is latent semantic analysis.

In some embodiments, each object embedding is obtained using a local context windows based method. Non-limiting examples of local context windows based method include, but are not limited to skip-gram and CBOW.

In some embodiments, each object embedding is obtained using GloVe. For more disclosure on GloVe, see chapter 4 (Advanced Word2vec) of Ganegedra, 2018, Natural Language Processing with Tensorflow, Packt Publishing Ltd. Birmingham, UK, which is hereby incorporated by reference.

Blocks 412-424. With reference to block 412 of FIG. 4A, the first plurality of object embeddings is used to determine a first plurality of morphism embeddings for a first plurality of morphisms 130 for the first dataset. Section 2.3.1, below, provides a description of a morphism 132 and how a morphism embedding 140 defines a relationship between the embeddings of a pair of objects in a strict sense. Section 2.3.2, below, provides a description of a morphism 132 and how a morphism embedding 140 defines a relationship between the embeddings of a pair of objects in a less restrictive (probabilistic) sense. Section 2.3.3, below, provides a description of how morphism embedding 140 for morphisms between objects is learned from statistics derived from analysis of the context of objects in the first dataset 120.

In some embodiments, each respective morphism embedding 140 in the first plurality of morphism embeddings represents a morphism 132 in the first plurality of morphisms between a respective first 134 and second object 136 in the first plurality of objects, where the respective morphism embedding, when multiplied by the object embedding of the respective first object in the first plurality of object embeddings, realizes with a first threshold probability the object embedding of the respective second object in the first plurality of object embeddings. In other words, in some embodiments a morphism embedding 140 defines a relationship between the embeddings of a pair of objects in a less restrictive (probabilistic) sense in accordance with Section 2.3.2. below.

In some embodiments, an object embedding 126 of a respective first object 122 is in the form of a first vector, the object embedding 126 of the respective second object 122 is in the form of a second vector, and the respective morphism embedding 140 is in the form of a matrix. In some embodiments, the matrix representing the morphism embedding 140 has 10 or more elements, 100 or more elements, 200 or more elements, 500 or more elements, 1000 or more elements, 2000 or more elements, or 5000 or more elements.

In some embodiments, the threshold probability needed to accept a morphism 132 into the first plurality of morphisms 130 is application dependent. In some embodiments the threshold probability is a probability between 10 percent and 90 percent. In some embodiments, the threshold probability is ten percent, fifteen percent, twenty percent, twenty-five percent, thirty percent, thirty-five percent, forty percent, forty-five percent, fifty percent, fifty-five percent, sixty percent, sixty-five percent, seventy percent, seventy-five percent, eighty-percent, eighty-five percent or ninety percent.

With reference to block 414 of FIG. 4A, in some embodiments the first plurality of objects comprises more than fifty objects, the first plurality of object embeddings comprises more than fifty object embeddings, and the first plurality of morphism embeddings comprises more than fifty morphism embeddings. In some embodiments the first plurality of objects comprises more than 60, more than 100, more than 1000, more than 10,000, more than 100,000 or more than 1 million objects, the first plurality of object embeddings comprises more than 60, more than 100, more than 1000, more than 10,000, more than 100,000 or more than 1 million object embeddings, and the first plurality of morphism embeddings comprises more than more than 60, more than 100, more than 1000, more than 10,000, more than 100,000 or more than 1 million morphism embeddings.

With reference to block 416 of FIG. 4B, in some embodiments a respective morphism embedding in the first plurality of morphism embeddings representing a morphism between a respective first object a and a respective second object b in the first plurality of objects is determined by refining a loss function [symbol] that includes a linking probability between a and b and an unlinking probability for a set of pairs (a, b′), where each respective b′ in the set of pairs is an object in the first plurality of objects. In some embodiments in accordance with block 416, the respective morphism embedding is determined by refining a loss function further described in Section 2.3.3, below. For instance, referring to block 418 of FIG. 4B, in some embodiments, the loss function [symbol] has the form

$$ℒ = {𝔼}_{( a , b ) ∼ p ( a , b )} ( log P ( a \to b ) ) + {𝔼}_{( a ) ∼ p ( a )} ( {𝔼}_{{b}^{′} ∼ {p}_{N} ( {b}^{′} )} ( log ( 1 - P ( a \to {b}^{′} ) ) ) ) , \\ where , \\ P ( a \to b ) = sigmoid ( z ( a \to b ) ) ≡ \frac{{e}^{z ( a \to b )}}{1 + {e}^{z ( a \to b )}} , \\ z ( a \to b ) = {agg}_{f} z ( a {\to }^{f} b ) , \\ z ( a {\to }^{f} b ) = {v}_{b}^{T} {M}_{f} {v}_{a} ,$$

M_{f} is a respective morphism embedding representing the morphism f between a and b, vₐ is the object embedding of a in the first plurality of object embeddings, v_{b}^{T} is a transpose of the object embedding of b in the first plurality of object embeddings,

$$z ( a {\to }^{f} b )$$

is a score function that evaluates the respective morphism f between a and b, given by v_{b}^{T}M_{f}vₐ, or by a neural network that takes M_{f}, vₐ, and v_{b} as input and returns a scalar score,

$${agg}_{f} z ( a {\to }^{f} b )$$

is an aggregation of the score for the morphism f between a and b into a final score z(a→b), z(a→b) is a logit that determines P(a→b), P(a→b) is a linking probability that a and b are related by one or more morphisms, 1−P(a→b′) is an unlinking probability describing a probability that a and b are not related by one or more morphisms,

$${𝔼}_{( a , b ) ∼ p ( a , b )} ( log P ( a \to b ) )$$

is expectation of the log likelihood of the linking probability given (a, b)˜p(a, b), (a, b)˜p(a, b) is a sampling distribution across pairs of objects in the first concurrence scope drawn from the first dataset,

$${𝔼}_{( a ) ∼ p ( a )} ( {𝔼}_{{b}^{′} ∼ {p}_{N} ( {b}^{′} )} ( log ( 1 - P ( a \to {b}^{′} ) ) ) )$$

is the expectation of the log likelihood of the unlinking probability given (a)˜p(a), and b′˜p_{N}(b′), a˜p(a) is a marginal distribution of a across objects drawn from the first dataset, and b′˜p_{N}(b′) is a negative sampling distribution of b′ across objects drawn from the first dataset. See Section 2.3.3 below for more discussion of this loss function.

Thus, consider the case in which there are objects a and b in the dataset and the goal is to determine the morphism embedding M_{f} of the morphism f between a and b. From block 406, there exists an object embedding for a, which can be denoted vₐ, and an object embedding for b, which can be denoted v_{b}. For the above loss function [symbol] , vₐ and v_{b} are in the form of vectors and M_{f} is in the form of a matrix. The goal of training is to find the best vector values of vₐ and v_{b} and the best matrix values of M_{f} to maximize the loss function [symbol] . In other words, loss function [symbol] is used to refine both the morphism embedding values M_{f} and the object embeddings vₐ, v_{b} together. To evaluate [symbol] , the equation

$$z ( a \to b ) = {agg}_{f} z ( a {\to }^{f} b ) ,$$

is used. In this equation, agg_{f} is the aggregation (e,g., summation, maximization, softmax, or a generic neural network, etc.) that aggregates

$$z ( a {\to }^{f} b )$$

into a final score z(a→b). In some embodiments,

$$z ( a {\to }^{f} b )$$

is a score function that evaluates the morphism f from a to b. In some embodiments,

$$z ( a {\to }^{f} b )$$

has the form:

$$z ( a {\to }^{f} b ) = {v}_{b}^{T} {M}_{f} {v}_{a} .$$

That is, in some embodiments

$$z ( a {\to }^{f} b )$$

is a score function that evaluates the morphism M_{f} from a to b given by the vector-matrix-vector inner product where v_{b}^{T}M_{f} vₐ (where v_{b}^{T} is the transpose of v_{b}. In some embodiments, M_{f} is derived using a neural network. For instance, in some embodiments, the matrix values of M_{f}, which initially are random values in some embodiments, are encoded as hidden weights of the neural network and the input to this neural network are vₐ and v_{b} (or v_{b}^{T}) and the output is a scalar score

$$z ( a {\to }^{f} b ) .$$

Thus, with

$$z ( a \to b ) = {agg}_{f} z ( a {\to }^{f} b )$$

determined, it is possible to calculate

$$P ( a \to b ) = sigmoid ( z ( a \to b ) ) ≡ \frac{{e}^{z ( a \to b )}}{1 + {e}^{z ( a \to b )}}$$

and thus provide the term P(a→b) in [symbol] . In [symbol] , the log of P(a→b) is taken as an expectation given the distribution (a, b)˜p(a, b), which can be estimated by sampling (a, b)˜p(a, b) according to the distribution across pairs of objects in the first concurrence scope drawn from the first dataset. In this way,

$${𝔼}_{( a , b ) ∼ p ( a , b )} ( log P ( a \to b ) ) ,$$

the expectation of the log likelihood of the linking probability P(a→b) given (a, b)˜p(a, b) is calculated.

The loss function [symbol] further requires the unlinking probability 1−P(a→b′) for b′˜p_{N}(b′), a negative sampling distribution of b′ across objects drawn from the first dataset. In some embodiments, five or more, ten or more, twenty or more, thirty or more, or one hundred or more different b′ within the first dataset are drawn to compute

$${𝔼}_{{b}^{′} ∼ {p}_{N} ( {b}^{′} )} ( log ( 1 - P ( a \to {b}^{′} ) ) ) .$$

For each such b′, the same equations used to quantify the linking probability are used, now just using the object embedding for b′ (v_{b′}) instead of v_{b}. Thus, the equation

$$z ( a \to {b}^{′} ) = {agg}_{f} z ( a {\to }^{f} {b}^{′} ) .$$

is calculated where agg_{f} is the aggregation (e,g., summation, maximization, softmax, or a generic neural network, etc.) that aggregates

$$z ( a {\to }^{f} {b}^{′} )$$

into a final score z(a→b′). In some embodiments,

$$z ( a {\to }^{f} {b}^{′} )$$

is a score function that evaluates the morphism f from a to b′. In some embodiments,

$$z ( a {\to }^{f} {b}^{′} )$$

has the form:

$$z ( a {\to }^{f} {b}^{′} ) = {v}_{b}^{T} , {M}_{f} {v}_{a} .$$

That is, in some embodiments

$$z ( a {\to }^{f} {b}^{′} )$$

is a score function that evaluates the morphism M_{f} from a to b′ given by the vector-matrix-vector inner product where v_{b′}^{T}M_{f}vₐ (where v_{b′}^{T} is the transpose of v_{b′}. In some embodiments, M_{f} between a and b′ is derived using a neural network, just like the M_{f} between a and b were derived above. For instance, in some embodiments, the matrix values of M_{f}, which initially are random values in some embodiments, are encoded as hidden weights of the neural network and the input to this neural network are vₐ and v_{b′} (or v_{b′}^{T}) and the output is a scalar score

$$z ( a {\to }^{f} {b}^{′} ) .$$

Thus, with

$$z ( a \to {b}^{′} ) = {agg}_{f} z ( a {\to }^{f} {b}^{′} ) ,$$

determined, it is possible to evaluate for

$$P ( a \to {b}^{′} ) = sigmoid ( z ( a \to {b}^{′} ) ) ≡ \frac{{e}^{z ( a \to {b}^{′} )}}{1 + {e}^{z ( a \to {b}^{′} )}}$$

and thus provide P(a→b′) for each b′ in calculating [symbol] . After evaluation of the loss function [symbol] , standard machine learning packages like PyTorch or TensorFlow can be used to automatically evaluate the gradient of the loss function [symbol] with respect to the starting values for the vector (vₐ and v_{b}) and matrix elements (M_{f}). In some embodiments, these elements are then updated by gradient descend/ascend, which is also implemented by machine learning packages.

With reference to block 420 of FIG. 4C, in some embodiments p(a)=Σ_{b}p(a, b) and is a marginalization of the joint distribution p(a, b) of concurrence probability, and p_{N}(b′) can either be taken as the marginal distribution or a fractional power p_{N}(b′)^{k} of the marginal distribution, where k is a positive integer.

With reference to block 422 of FIG. 4C, in some embodiments the loss function comprises encoding each matrix value for M_{f} as a corresponding hidden weight in a neural network that is configured to solve for v_{b}^{T}M_{f} vₐ upon inputting vₐ and v_{b} into the neural network and using the output of the neural network upon inputting vₐ and v_{b} to refine each matrix value for M_{f} in accordance with the loss function.

With reference to block 424 of FIG. 4C, in some embodiments, the loss function is optimized by gradient decent or gradient ascent, or some other form of refinement schedule. For instance, in some embodiments after evaluation of the loss function, standard machine learning packages like PyTorch or TensorFlow are used to automatically evaluate the gradient of the loss function with respect to the initial vector and matrix elements for vₐ, v_{b} and M_{f}. In some embodiments, these elements are then be updated by gradient descend/ascend, which is also implemented by machine learning packages.

In some embodiments rather than using the above loss function, a loss function that does not take into consideration an unlinking probability is used to determine a respective morphism embedding. For instance, in some embodiments the matrix components of the morphism embedding between objects a and b are determined by inputting both vₐ (or the transpose thereof), v_{b} (or the transpose thereof) into a neural network in which the initial values for the matrix components of the morphism embedding between objects a and b have been encoded as hidden weights. The desired output of the neural network is the scalar value zero. Accordingly, the hidden weights of the neural network, and thus the morphism embedding, is refined using backpropagation techniques until the neural network outputs the scalar value of zero upon input of vₐ (or the transpose thereof), v_{b} (or the transpose thereof). The final values of the hidden weights are then accepted as the morphism embedding between objects a and b.

Block 426. With reference to block 426 of FIG. 4C, a plurality of linking probabilities is determined. Each respective linking probability in the plurality of linking properties is between a corresponding first object a and a corresponding second object b in first plurality of objects, using each morphism in the first plurality of morphisms between the corresponding first object a and the corresponding second object b. For instance, the linking probability between a and b is the term P(a→b) which can be solved as described above and as further described in Section 2.3.3 below.

Block 428-432. With reference to block 428 of FIG. 4C, a corresponding composite object v_{a\textcircled{×}b} is added to the first plurality of objects for each respective pair of objects (a, b) in the first plurality of objects when the linking probability P(a→b) between the respective pair of objects exceeds a threshold value, thereby adding a plurality of composite objects to the first plurality of objects. The threshold value is application dependent. In some embodiments, the threshold value is a value chosen between 10 percent and 90 percent. In some embodiments, the threshold value is a value chosen between 20 percent and 80 percent. In some embodiments, the threshold value is a value chosen between 30 percent and 70 percent. In some embodiments, the threshold value is a value chosen between 40 percent and 60 percent. With respect to block 430, in some embodiments the corresponding composite object v_{a\textcircled{×}b} is calculated as a tensor bifunctor

v_{a\textcircled{×}b}=Φ(vₐ\textcircled{×}v_{b}),

where, vₐ\textcircled{×}v_{b} is implemented as a Kronecker product, and Φ is a projection matrix that maps vₐ\textcircled{×} v_{b} to v_{a\textcircled{×}b} linearly, or a neural network that maps vₐ\textcircled{×}v_{b} to v_{a\textcircled{×}b} non-linearly as further described in Sections 2.5.1 and 2.5.2, below. With respect to block 432 of FIG. 4C, in some embodiments, for each respective composite object in the plurality of composite objects, the disclosed systems and methods track the number of elemental objects used to form the respective composite object. In other embodiments this information is not explicitly tracked. The addition of composite objects to the first plurality of objects greatly enriches the capability of the disclosed machine learning algorithms. Such composite objects inherently encode the relationships between objects. Thus, if there is a match of a composite object between a search query and a corpus or other target dataset, that match is often more meaningful than a match of an elemental object between a search query and a corpus or other target dataset. By searching for matches of complex objects formed in accordance with blocks 428-432 before searching for matches between elemental objects, the disclose machine learning algorithm achieve improved performance and require fewer computer resources to run for comparable performance with conventional machine learning approaches.

Block 434. Referring to block 434 of FIG. 4D, in some embodiments the using 412, determining 426, and adding 428 are repeated until a repetition criterion is achieved. Referring to block 436 of FIG. 4D, in some embodiments the repetition criterion is a failure to identify any additional objects in the first plurality of objects that has a linking probability that exceeds the threshold value. In other embodiments, the repetition criterion is simply a predetermined number of repeats of the using 412, determining 426, and adding 428 blocks (e.g., a single repeat, two repeats, three repeats, four repeats, etc). Because the identity of the objects in the first plurality of objects changes, each instance of block 412 requires the relearning of the first plurality of morphism embeddings, and each instance of block 426 requires the relearning of the plurality of linking probabilities.

Block 438. Block 438 of FIG. 4D illustrates the use of different concurrence scopes as further described in Section 2.3.4 below. Thus, referring to block 438 of FIG. 4D, in some embodiments a second plurality of object embeddings for the first dataset is obtained. Each respective object embedding in the second plurality of object embeddings is a respective vector represents a plurality of properties of a different object in the first plurality of objects within a second concurrence scope. The second concurrence scope is different from the first concurrence scope. In one non-limiting illustrative example, the first concurrence scope is a scan of 10 concurrent words and the second concurrence scope is a scan of 5 concurrent words in document in the first database. In another non-limiting illustrative example, the first concurrence scope is a scan of sentences and the second concurrence scope is a scan of paragraph in documents in the first database.

A respective morphism embedding in the first plurality of morphism embeddings representing a morphism between a respective first object a and a respective second object b within the first concurrence scope in the first plurality of objects is determined by refining a first loss function that includes a linking probability between a and b, P(a→b), and an unlinking probability for a first set of pairs (a, b′). Each b′ in the first set of pairs is an object in the first plurality of objects in the first concurrence scope that is not identified as linked with a.

A respective morphism embedding in the first plurality of morphism embeddings representing a morphism between a respective first object c and a respective second object d within the second concurrence scope in the first plurality of objects is determined by refining a second loss function that includes a linking probability between c and d, P(c→d), and an unlinking probability for a second set of pairs (c, d′). Each d′ in the second set of pairs is an object in the second plurality of objects in the second concurrence scope that is not identified as linked with c.

Block 440. Referring to block 440 of FIG. 4D, a search query comprising a second plurality of objects in the first category is received. The search query can be, for example “John is in San Francisco.”

Block 442. Referring to block 442 of FIG. 4D, the first plurality of objects (including one or more composite objects) is used to identify a match to the search query. For instance, a possible composite object is the fusion of John and San Francisco.

Blocks 444-448. Blocks 444-448 illustrate the advantageous nature of the use of the disclosed composite objects in improving machine learning performance and/or efficiency. Referring to block 444 in some embodiments, prior to the adding 428, the first plurality of objects consists of a plurality of elemental objects, and upon achievement of the repetition criterion, the first plurality of objects comprises: a first subset of composite objects, where each composite object in the first subset of composite objects is a composite of a first number of elemental objects in the plurality of elemental objects, a second subset of composite objects, where each composite object in the second subset of composite objects is a composite of a second number of elemental objects in the plurality of elemental objects, and a third subset of composite objects, where each composite object in the third subset of composite objects is a composite of a third number of elemental objects in the plurality of elemental objects, where the first number is greater than the second number and the second number is greater than the third number. For instance, referring to block 446 of FIG. 4E, in one example, the first number is 4, the second number is 3, and the third number is 2. In fact, there is no limit to how many “layers” of composite objects there can be using the disclosed systems and methods, and the use of three different subset classes of composite objects is merely illustrative.

Turning to block 448 of FIG. 4E, in some embodiments the using the first plurality of objects to identify a match to the search query comprises: (i) combing the second plurality of elemental objects for a match between a composite object in the first subset of composite objects and the second plurality of objects, (ii) combing, after the combing (i), the second plurality of objects for a match between a composite object in the second subset of composite objects and the second plurality of objects, (iii) combing, after the combing (ii), the second plurality of objects for a match between a composite object in the third subset of composite objects and the second plurality of objects; (iv) optionally combing, after the combing (iii), the second plurality of objects for a match between a non-composite object in the second plurality of objects and the plurality of elemental objects; (v) using each match from the combing (i), the combing (ii), the combing (iii), and optionally the combing (iv) to identify a match between a non-composite object in the second plurality of objects and the plurality of elemental objects; and (vi) using each match from the combing (ii), the combing (iii), the combing (iv), and optionally the combing (v) to either (A) identify an image in a plurality of images for the search query string, where the plurality of images are in the first category, or (B) identify document in a plurality of documents for the search query string, where the plurality of documents are in the first category. That is, the more complex objects are used to find matches, then less complex objects and so forth. In fact, by working down form the more complex objects to simpler objects when servicing a search query, it may not even be necessary to consider the single objects in order to find one or more suitable matches to the search query. Thus, when this occurs, fewer object vectors (embeddings) need to be evaluated for the match, making the machine learning process more efficient. Moreover, matches of complex objects are likely to have more significance than matches of elemental objects, thereby improving performance.

1.1. Approach

The present disclosure provides a novel machine learning framework based on category theory in pure mathematics that enables the algorithm to automatically discover feature representations of both objects and their interrelations from data; and provides universal approaches toward various machine learning tasks on categorical data, including classification, translation and generation of categories. In machine learning, feature learning or representation learning is an important direction that allows the machine to learn the representation of different objects in the data set as different feature vectors, and use the learned features to perform various tasks based on the data set. The goal of the proposed research is to promote current representation learning approaches from set-theoretic to category-theoretic, and from object-oriented to relation-oriented. One feature of the disclosed approaches is an emphasis on learning of relations (morphisms) between objects and representing them as matrices (or tensors) in the feature space. The learned matrix encoding of relations can be directly used to drive the learning of various tasks, such as unsupervised translation and structure generation, which cannot be achieved with object embeddings only.

1.2. Categorical Representation Learning

The present disclosure describes a novel machine learning architecture in a framework denoted as “categorical representation learning”, which seeks a hierarchical representation of the dataset for a given language, modeling it as a “higher” category (parametrizing objects, 1-morphisms (morphisms of objects), 2-morphisms (morphisms between morphisms), . . . n-morphisms), and applies a multi-fold construction of tensor categories (or monoidal categories in mathematics) that results in encoding single words (and their relations) in the given language dataset, as well as 2-word combinations (and their relations), 3-word combinations (and their relations), . . . , n-word combinations and their relations in an ambient vector space. One interesting aspect of the construction, distinguishing it from abstract constructions of category theory in pure mathematics, is that the category-theoretic ideas being used in the present disclosure are adapted for machine learning and artificial intelligence purposes, that is, they include concepts from probability theory and quantum field theory. Roughly speaking, the higher relations are modeled in some embodiments of the present disclosure as stochastic morphisms, called “fuzzy morphisms”, and the same goes for the monoidal categories that fuse words into more complex phrases. The final outcome of constructions of the present disclosure is to model a given language dataset as an (enriched) union of higher categories, similar to a “simplicial chain complex”, associates to a topological space.

1.3 Broader Impacts

Category theory is a mathematical framework that attempts to define mathematical objects through their relationships. However, the idea of category theory has not yet been applied to modern machine learning. One aspect of the present disclosure is the exploration of how to mine the categorical structure from the data, and what category theory can brings to machine learning. One immediate impact of the formalism of the present disclosure is to design Natural Language Processing (NLP) algorithms, exhibiting far more capabilities over commonly used NLP algorithms in industry (such as GOOGLE transformer, etc.). The present disclosure provides the basis for creating the next generation of NLP algorithms, implementing central ideas borrowed from algebraic geometry (AG) and category theory in pure mathematics, as well as quantum mechanics in physics.

2. Overview

2.1 Motivation

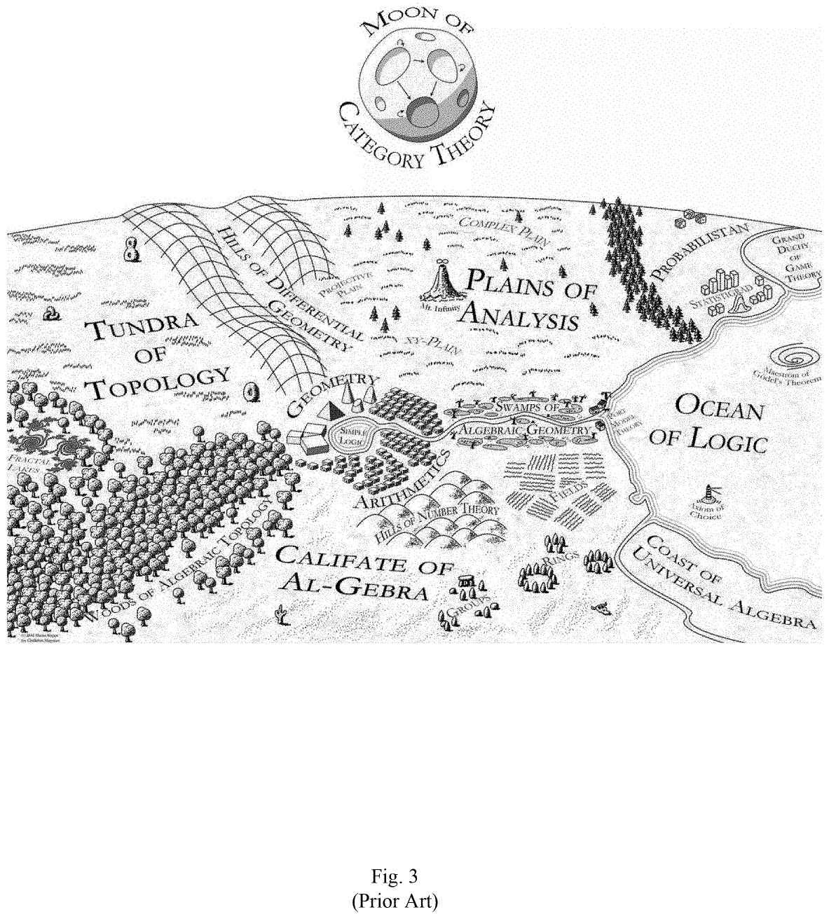

The rise of category theory was a great revolution of mathematics in the 20th century. Martin Kuppe once created a wonderful map of the mathematical landscape (see FIG. 3) in which category theory hovers high above the ground, providing a sweeping vista of the terrain. It provides a basis for seeing relationships between various fields that are otherwise imperceptible at ground level, attesting that seemingly unrelated areas of mathematics aren't so different after all. A category describes a collection of objects together with the relations (called morphisms) between them. The concept of category has provided a unified template for different branches of mathematics. It is expected to be suitable for modeling datasets with relational structures, such as semantic relations among words, phrases and sentences in language datasets, or social relations among people or organizations in social networks.

From the category perspective, relationships are significant. Objects can be defined through their interrelations. So far, the field of representation learning has remained focused on learning object encodings, following the idea of “everything to vector”. More recently, graph neural network models and self-attentive mechanisms have begun to model relationships between objects, but they still did not place relationships in the first place. The present disclosure develops a novel machine learning framework, called categorical representation learning, that directly learns the representation of relations as feature matrices (or tensors). The learned relations are then used in different tasks. For example, direct relations can be composed to reveal higher-order relations. A functor map between different categories can be learned by aligning the relations (morphisms). Relations can guide the algorithm to identify clusters of objects and to perform renormalization transformations to simplify the category.

2.2 Specific tasks

The present disclosure defines three general tasks.

Task 1: Mine the categorical structure from data.

The objective of task 1 is to develop the categorical representation learning approach, which enables the extraction of the representation of objects and morphisms from data. The approach developed in this task provides a foundation of the present disclosure that provides the morphism representation to drive further applications.

Task 2: Align the categorical structures between datasets.

The objective of task 2 is to provides a functorial learning approach, which establishes a functor between categories based on the learned categorical representations by aligning the morphism representations. The technique developed in this task finds applications in unsupervised (or semi-supervised) translation.

Task 3: Discover hierarchical structures with tensor categories.

Task 3 combines the categorical representation learning and functorial learning in the setting of a tensor category to learn the tensor functor that fuses simple objects into composite objects. The approach enables the algorithm to perform renormalization group transformations on categorical dataset, which progressively simplifies the category structure. This has broad applications in classification and generation tasks of categories.

2.3 Task 1: Mine the Categorical Structure from Data

A category [symbol] consists of a class [symbol] bj(C) of objects and a class [symbol] om( [symbol] ) of morphisms. Each morphism f connects a source object a to a target object b, denoted as f: a→b. The hom-class [symbol] om(a, b) collects all morphisms from a to b. Morphisms can be composed. The composition is a binary operation ∘: [symbol] om(a, b)×Hom(b, c)→Hom(a, c) defined for every three objects a, b, c. The composition of f: a→b and g: b→c is written as g∘f. The composition is associative, such that h∘(g∘f)=(h∘g)∘f. For every object x there exists an identity morphism idₓ: x→x, such that for every morphism f: a→x and g: x→b, one has idₓ∘f=f and g∘idₓ=g, that is, pre- and post-compositions of morphisms in the category with the identity morphism will leave them unchanged.

One can associate a geometric space to a given category. For this one needs to embed the category into an ambient geometric space, realizing the latter also as a category. Take for instance a category [symbol] in which every object a is mapped to a vector vₐ in an ambient geometric space R, and every morphism between two objects in [symbol] , f: a→b, is mapped to a morphism between vectors vₐ, v_{b} in R. Since R is a vector space, a morphism between two vectors is then realized in R as a matrix M_{f}: vₐ→v_{b}. The object and morphism embeddings, discussed above, will be implemented by separate embedding layers in a neural network. f is a morphism from object a to object b, iff (if and only if) the embedding matrix can transform the embedding vectors as v_{b}=M_{f}vₐ under matrix-vector multiplication. The composition of morphisms is then realized as matrix-matrix multiplications as M_{g∘f}=M_{g}M_{f}, which is naturally associative. The identity morphism of an object x∈ [symbol] is represented as the projection operator M_{id}_{ₓ}=vₓvₓ^{T}/|vₓ|². In this manner, the category structure is represented by the object, and morphism embeddings in the feature space.

2.3.2 Fuzzy Morphisms

In machine learning, the relation between objects may not be strict, that is M_{f}vₐ will not match v_{b} precisely, but only align with v_{b} with a high probability. To account for the fuzziness of relations then, the statement off: a→b is replaced by the probability of f belonging to the class [symbol] om(a, b) in some embodiments:

$$P ( f ∈ ℋ om ( a , b ) ) ≡ P ( a {\to }^{f} b ) ∝ exp z ( a {\to }^{f} b ) , \qquad ( 1 )$$

which is parameterized by the logit

$$z ( a {\to }^{f} b ) ∈ ℝ .$$

The logit proposed to be modeled by

$$z ( a {\to }^{f} b ) = {v}_{b}^{T} {M}_{f} {v}_{a} , \qquad ( 2 )$$

such that if v_{b} and M_{f}vₐ align in similar directions, the logit will be positive, which results in a high probability for the morphism f to connect a to b. The objects a and b are said to be related (linked) if there exists at least one morphism connecting them. The linking probability is then proportional to the sum of the likelihood of each candidate morphism,

$$P ( a \to b ) ∝ {\sum }_{f} exp z ( a {\to }^{f} b ) .$$

The probability is normalized by considering the unlinking likelihood as the unit. Thus the binary probability P(a→b) can be modeled by the sigmoid of a logit z(a→b) that aggregates the contributions from all possible morphisms,

$$P ( a \to b ) = sigmoid ( z ( a \to b ) ) ≡ \frac{{e}^{z ( a \to b )}}{1 + {e}^{z ( a \to b )}} \\ \begin{matrix}z ( a \to b ) = log {\sum }_{f} exp z ( a {\to }^{f} b ) \\ = log {\sum }_{f} exp ( {v}_{b}^{T} {M}_{f} {v}_{a} ) .\end{matrix} \qquad ( 3 )$$

2.3.3. Learning Morphism Embedding from Statistics

Unsupervised representation learning of the present disclosure develops feature representations from data statistics. In the categorical representation learning, the object and morphism embeddings are learned from the concurrence statistics, which corresponds to the probability p(a, b) that a pair of objects (a, b) occurs together in the same composite object. For example, two concurrent objects could stand for two elements in the same compound, or two words in the same sentence, or two people in the same organization. Concurrence does not happen for no reason. Assuming that two objects appearing together in the same structure can always be attributed to the fact that they are related by at least one type of relation, then the linking probability P(a→b) can be maximized for the observed concurrent pair (a, b) in the dataset.

The negative sampling method can be adopted to increase the contrast. For each observed (positive) concurrent pair (a, b), the object b will be replaced by a random object b′, drawn from the negative sampling distribution p_{N}(b) among all possible objects. The replaced pair (a, b′) will be considered to be an unrelated pair of objects. Therefore the training objective is to maximize the linking probability P(a→b) for the positive sample (a, b) and also maximize the unlinking probability P(a [symbol] b)=1−P(a→b′) for a small set of negative samples (a, b′),

$$ℒ = {𝔼}_{( a , b ) ∼ p ( a , b )} ( log P ( a \to b ) + {𝔼}_{{b}^{′} ∼ {p}_{N} ( {b}^{′} )} log ( 1 - P ( a \to {b}^{′} ) ) ) \qquad ( 4 )$$

With the model of P (a→b) in Eq. (3), the object embedding vₐ and morphism embedding M_{f} can be trained by maximizing the objective function [symbol] . The negative sampling distribution p_{N}(b′) can be engineered, but one natural choice is to take the marginalized object distribution p_{N}(b′)=p(b′)=ₐp(a, b′). A theoretical optimum (Levy and Goldberg, 2014, “Neural word embedding as implicit matrix factorization,” in Advances in neural information processing systems, pages 2177-2185) is achieved with the following logit

$$z ( a \to b ) = log \frac{p ( a , b )}{p ( a ) p ( b )} = PMI ( a , b ) , \qquad ( 5 )$$

which learns the point-wise mutual information (PMI) between objects a and b. If the objects were not related at all, their concurrence probability should factorize to the product of object frequencies, i.e. p(a, b)=p(a)p(b), implying zero PMI. So a non-zero PMI indicates non-trivial relations among objects: a positive relation (PMI>0) enhances p(a, b) while a negative relation (PMI<0) suppresses p(a, b) relative to p(a)p(b). By training the logit z(a→b) to approximate the PMI, the relations between objects are discovered and encoded as the feature matrix M_{f} of morphisms.

2.3.4 Scope of Concurrence

It is noted that the definition of concurrence depends on the scope (or the context scale). For example, the concurrence of two words can be restricted in the scope of phrases or sentences or paragraphs. Different choices for the concurrence scope (say length of sentences, or phrases being considered) will affect the concurrent pair distribution p(a, b), which then leads to different results for the object and morphism embeddings. This implies that objects may be related by different types of morphisms in different scopes. The categorical representation learning approach mentioned above can be applied to uncover the morphism embeddings in a scope-dependent manner. Eventually, the different object and morphism embeddings across various scopes can further be connected by the renormalization functor, which maps the category structure between different scales, detail of which will be elaborated in later sections. The scope-dependent categorical representation learning will form the basis for the development of unsupervised renormalization technique for categories with hierarchical structures, which will find broad applications in translation, classification, and generation tasks.

2.3.5. Connection to Multi-Head Attention

The multi-head attention mechanism consists of two steps. The first step is a dynamic link prediction by the “query-key matching”, that the probability to establish an attention link from a to b is given by

$$P ( a {\to }^{f} b ) ∝ exp z ( a {\to }^{f} b )$$

with f labeling the attention head. The logit is computed from the inner product between the query vector, Q_{f}v_{b}, and the key vector, K_{f}vₐ, as

$$z ( a {\to }^{f} b ) = {v}_{b}^{T} {Q}_{f}^{T} {K}_{f} {v}_{a} , \qquad ( 6 )$$

which can be written in the form of Eq. (2) if M_{f}=Q_{f}^{T}K_{f}. The second step is the value propagation by graph convolution. Focusing on the first step of dynamic link prediction, the linking probability model in Eq. (3) resembles the multi-head attention mechanism with the morphism embedding M_{f}=Q_{f}^{T}K_{f} given by the product of query and key matrices for each attention head. The proposal of the categorical representation learning is to keep the learned attention heads as an encoding of relations in the feature space, which can be further used in other task applications.

The matrix M_{f} can also be viewed as a metric in the feature space, which defines the inner product of object vectors. Different morphisms f correspond to different metrics M_{f}, which distort the geometry of the feature space differently (bring object embeddings together or pushing them apart). When there are multiple relations in the action, the feature space is equipped with different metrics simultaneously, which resembles the idea of superposition of geometries in quantum gravity.

If the single-head logit

$$z ( a {\to }^{f} b ) = {v}_{b}^{T} {M}_{f} {v}_{a}$$

is considered as an (negative) energy of two objects a and b embedded in a specific geometry, the aggregated multi-head logit z(a→b)=log τ_{f} exp

$$z ( a {\to }^{f} b )$$

is analogous to the (negative) free energy that the objects will experience in the ensemble of fluctuating geometries.

2.4 Task 2: Align the Categorical Structures Between Data Sets

2.4.1 Tasks as Functors

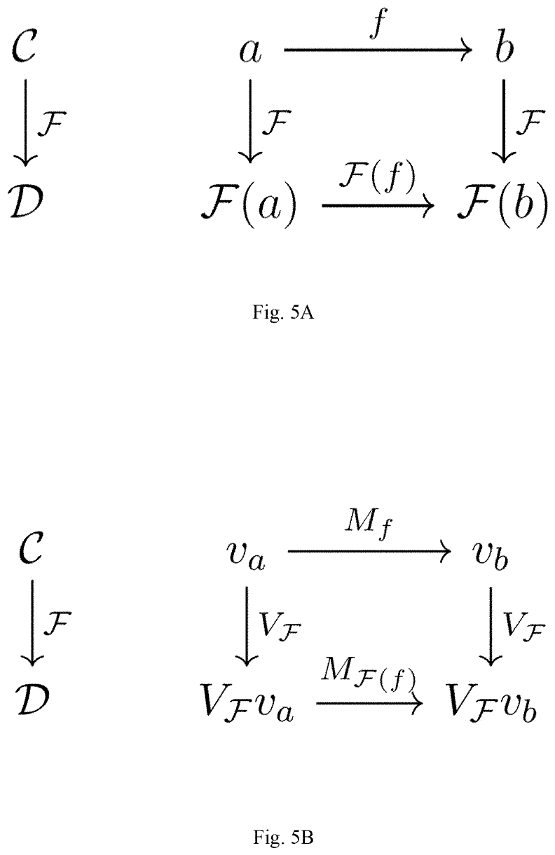

A functor denotes the structure-preserving map between two categories. A functor [symbol] from a source category [symbol] to a target category [symbol] is a mapping that associates to each object a in [symbol] an object [symbol] (a) in [symbol] , and associates to each morphism f: a→b in [symbol] a morphism [symbol] (f): [symbol] (a)→ [symbol] (b) in [symbol] , such that [symbol] (idₐ)= [symbol] for every object a in [symbol] and [symbol] (g∘f)= [symbol] (g)∘ [symbol] (f) for all morphisms f: a→b and g: b→c in [symbol] . The definition can be illustrated with the diagram provided in FIG. 5A.

A functor between two categories not only maps objects to objects, but also preserves their relations, which is essential in category theory. Many machine learning tasks can be generally formulated as functors between two data categories. For example, machine translation is a functor between two language categories, which not only maps words to words but also preserves the semantic relations between words. Image captioning is a functor from image to language categories, that transcribes objects in the image as well as their interrelations. Functorial learning is another important technique of the present disclosure, which provides universal approaches to enable the machine to learn the functorial maps between categories in an unsupervised or semisupervised manner.

2.4.2 Functorial Learning

In functorial learning, each functor [symbol] is represented by a transformation [symbol] that transforms the vector embedding vₐ of each object a in the source category to the vector embedding [symbol] of the corresponding object [symbol] (a) in the target category

[symbol]

= [symbol] (7)

and also transforms the matrix embedding M_{f} of each morphism in the source category to the matrix embedding [symbol] of the corresponding morphism [symbol] (f) in the target category

[symbol]

= [symbol] M_{f}, (8)

represented by the diagram provided in FIG. 5B.

In the case that the objects are embedded as unit vectors on a hypersphere, the functorial transformation [symbol] will be represented by orthogonal matrices, whose inverses are given by the transpose matrices [symbol] , which admit efficient implementation in the algorithm. The proposed representation for the functor automatically satisfies the functor axioms, as

[symbol]

_{(id}_{ₐ}₎= [symbol] ₍ₐ₎ [symbol] ₍ₐ₎= [symbol] vₐvₐ^{T} [symbol] = [symbol] M_{id}_{ₐ} [symbol] , and

[symbol]

_{(g∘f)}= [symbol] M_{g∘f} [symbol] = [symbol] M_{g}M_{f} [symbol] = [symbol] M_{g} [symbol] [symbol] M_{f} [symbol] = [symbol] _{(g)} [symbol] = [symbol] (9)

So as long as the optimal transformation [symbol] can be found, the disclosed design will ensure that it parametrizes a legitimate functor between categories.

2.4.3 Universal Structure Loss

Now an explanation of how to find the optimal transformation [symbol] is provided. One requirement for a functor is to preserve the morphisms between two categories. In some embodiments, the functor is trained by minimizing a loss function, which ensures the structural compatibility in Equation (8). The loss function is denoted by universal structure loss,

[symbol]

_{struc}=Σ_{f}∥ [symbol] − [symbol] M_{f}∥², (10)

given the matrix representation M_{f}, [symbol] of morphisms in both the source and target categories, which were obtained from the categorical representation learning. The loss function is universal in the sense that it is independent of the specific task that the functor is trying to model. In this approach, the morphism embeddings are all that are needed to drive the learning of functor transformation [symbol] . This is precisely in line with the spirit of the category theory: objects are defined by morphisms.

2.4.4. Alignment Loss

However, in reality, the learned morphism matrices M_{f} may not be of full rank. In such cases, the solution of the transformation [symbol] is not unique, because arbitrary transformation within the null space of the morphism matrix can be composed with [symbol] without a affecting the universal structure loss [symbol] _{struc}. To overcome this difficulty, in some embodiments, the universal structure loss is subsidized with additional alignment loss over a few pairs of aligned pairs of objects (a, [symbol] (a)),

[symbol]

_{align}= [symbol] ∥ [symbol] − [symbol] vₐ∥², (11)

where [symbol] is only a subset of objects in the source category. This provides additional supervised signals to train [symbol] by partially enforcing Eq. (7). In such embodiments, the total loss is a weighted combination of the structure loss and the alignment loss

[symbol]

= [symbol] _{struc}+λ [symbol] _{align}. (12)

By minimizing the total loss, [symbol] is trained, and the functor between categories can be established. The advantage of the categorical approach is that the structural loss already puts constraints on the parameters in [symbol] , so the effective parameter space for the alignment loss is reduced, such that the model can be trained with much less supervised samples when the category structure is rigid enough.

2.5 Task 3: Discover the Hierarchical Structures with Tensor Categories

2.5.1 Renormalization as Tensor Bifunctor

Renormalization plays a role in analyzing the hierarchical structures in physics and mathematics. It provides an efficient approach to extract the essential information of a system by progressively coarse graining the objects in the system. The categorical representation learning and functorial learning proposed in the previous two tasks provides a solid foundation to develop an unsupervised renormalization approach for machine learning in accordance with the present disclosure. This enables machines (e.g., computers) to summarize the feature representation of composite objects from that of each simple objects.

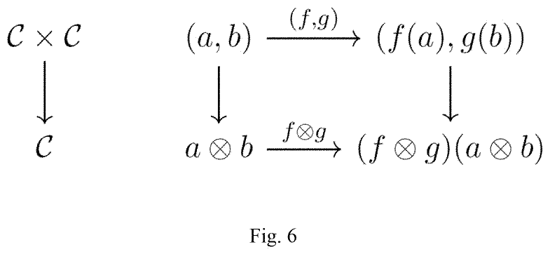

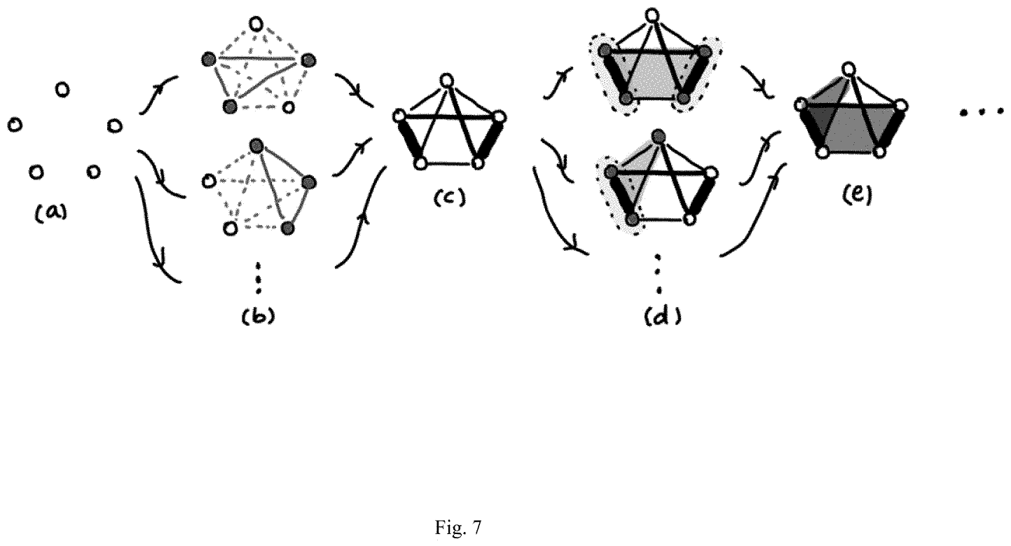

The elementary step of a coarse graining procedure is to fuse two objects into one composite object (or “higher” object). Multiple objects can then be fused together in a pairwise manner progressively. In category theory, the pairwise fusion of objects is formulated as a tensor bifunctor \textcircled{×}: [symbol] × [symbol] → [symbol] . The tensor bifunctor maps each pair of objects (a, b) to a composite object a b and each pair of morphisms (f, g) to a composite morphism f\textcircled{×}g while preserving the morphism relations between objects, as presented in FIG. 6.

The category equipped with the tensor bifunctor is called a tensor category (or monoidal category). Objects and morphisms of different hierarchies are treated within the same framework systematically. This enables the algorithm to model multi-scale structure in the data set with the universal approach of categorical representation learning.

2.5.2 Representing the Tensor Bifunctor

As a special case of general functors, the tensor bifunctor can be represented by a fusion operator Φ such that the object embeddings are fused by

v_{a\textcircled{×}b}=Φ(vₐ\textcircled{×}v_{b}), (13)

and the morphism embeddings are fused by

M_{f\textcircled{×}g}Φ=Φ(M_{f}\textcircled{×}M_{g}), (14)

following the general scheme in Eq. (7) and Eq. (8). The tensor product of the vector and matrix representations are implemented as Kronecker products. Φ can be viewed as a projection matrix that projects the tensor-product feature space back to the original feature space.

To simplify the construction, in some embodiments it is assumed that the representation of the tensor bifunctor is strict in the feature space, meaning that the fusion is strictly associative without non-trivial natural isomorphisms,

v_{a\textcircled{×}b\textcircled{×}c}=Φ(Φ(vₐ\textcircled{×}v_{b})\textcircled{×}v_{c})=Φ(vₐ\textcircled{×}Φ(v_{b}\textcircled{×}v_{c})). (15)

Such a strict representation will always be possible given a large enough feature space dimension, because every monoidal category is monoidally equivalent to a strict monoidal category. To impose the strict associativity in the learning algorithm, objects are fused within the same scope in random orders in some embodiments, such that the machine will not develop any preference over a particular fusion tree and will learn to construct an associative fusion operator Φ. With the fusion operator, the embedding can be established for all composite objects (and their morphisms) in the category given the embedding of fundamental objects (and their morphisms).

2.5.3. Multi-Scale Categorical Representation Learning

The tensor bifunctor learning can be combined with the categorical representation learning as an integrated learning scheme, which allows the algorithm to mine the category structure at multiple scales.

If the data set has naturally-defined levels of scopes, one can learn the objects and morphism embeddings in different scopes. The objective is to learn the concurrence of objects within their scope according to the loss function Eq. (4). For each pair of objects (a, b) drawn from the same scope, what is sought in accordance with some embodiments of the present disclosure is to maximize the linking probability P(a→b). For randomly sampled pairs of objects (a, b′), what is sought in accordance with some embodiments of the present disclosure is to maximize the unlinking probability P(a [symbol] b′)=1−P(a→b′). The linking probability P(a→b) is modeled by Eq. (3), based on the object and morphism embeddings. The vector embedding vₐ of a composite object a is constructed by recursively applying Φ to fuse from fundamental objects as in Eq. (15).

A more challenging situation is that the data set has no naturally-defined levels of scopes, such that the hierarchical representation must be established with a bootstrap approach. Assuming that at least a set of fundamental objects can be specified in the data set, as illustrated as small circles in FIG. 7(a). The categorical representation learning approach is first applied to learn the linking probability P(a→b) between objects. The algorithm first samples different clusters of objects from the data set within a certain scale. The linking probability is enhanced for the pair of objects concurring in the same cluster, and is suppressed otherwise, as shown in FIG. 7(b). In this way, the algorithm learns to find the embedding vₐ for every fundamental object a. After a few rounds of training, fuzzy morphisms among objects will be established, as depicted in FIG. 7(c). The thicker links represent higher linking probability P(a→b) and stronger relations. In later rounds of training, when the sampled cluster contains a pair of objects (a, b) connected by a strong relation (with P(a→b) beyond a certain threshold), it will be considered as a composite object f\textcircled{×}g, as yellow groups in FIG. 7(d). The embedding v_{a\textcircled{×}b} of the composite object will be calculated from that of the fundamental objects as v_{a\textcircled{×}b}=Φ(vₐ\textcircled{×}v_{b}), based on the fusion operator Φ given by the tensor bifunctor model. The model will continue to learn the linking probability P(a\textcircled{×}b→c) between the composite object a\textcircled{×}b and the other object c in the cluster, as red polygons in FIG. 7(d). In this way, the fusion operator Φ will get trained together with the object and morphism embeddings. This will establish higher morphisms between composite objects like FIG. 7(e). The approach can then be carried on progressively to higher levels, which will eventually enable the machine to learn the hierarchical structures in the data set and establish the representations for objects, morphisms and tensor bifunctors all under the same approach.

### EXAMPLES

### Example 1: Learning Chemical Compounds

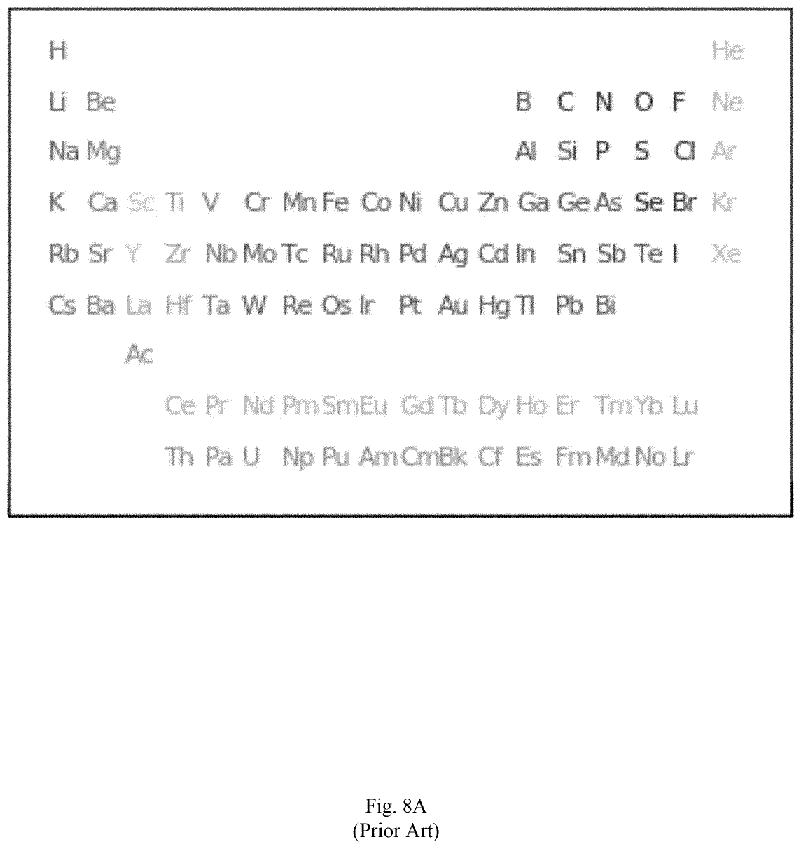

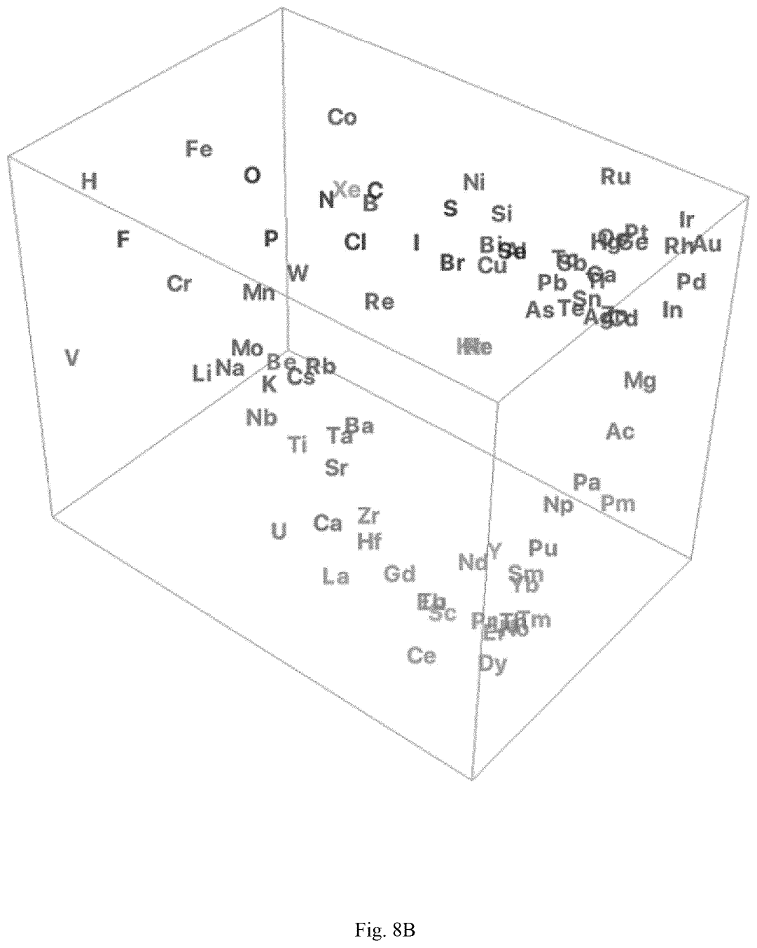

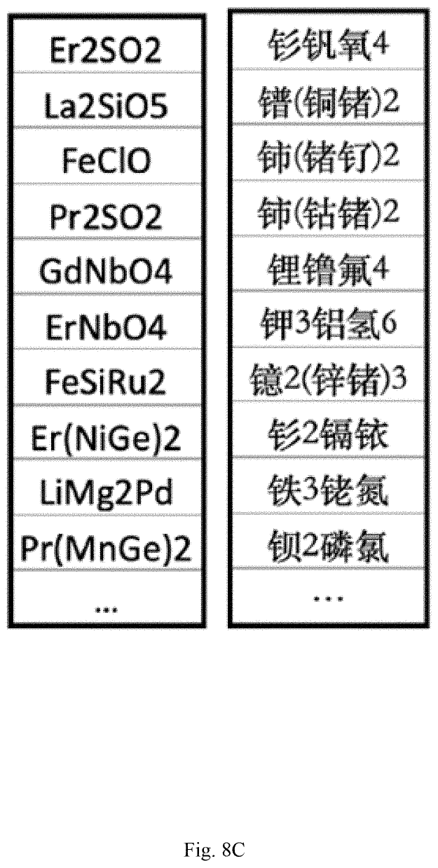

Data Set. To demonstrate the proposed categorical learning framework, the approach is applied to the inorganic chemical compound data set. The data set contains 61023 inorganic compounds, covering 89 elements in the periodic table FIG. 8A. The data set can be modeled by a category, which contains elements as fundamental objects, as well as functional groups and compounds as composite objects. The morphisms represent the relations (such as chemical bonds) between atoms or groups of atoms. It is assumed that the concurrence of two elements in a compound is due to the underlying relations, such that the morphisms can emerge from learning the elements' concurrence.

On the data set level, the point-wise mutual information (PMI) PMI(a, b)=log p(a, b)−log p(a)−log p(b) can be collected, where p(a, b) is the probability for the pair of elements a, b to appear in the same chemical compound, and p(a) is the marginal distribution. Performing a principal component analysis of the PMI and taking the leading three principal components provides three-dimensional vector encodings of elements, as shown in FIG. 8B. From FIG. 8B, it is seen that elements of similar chemical properties are close to each other, because they share similar context in the compound. This observation indicates that our algorithm is likely to uncover such relations among elements from the data set.

### Example 2: Unsupervised/Semisupervised Translation

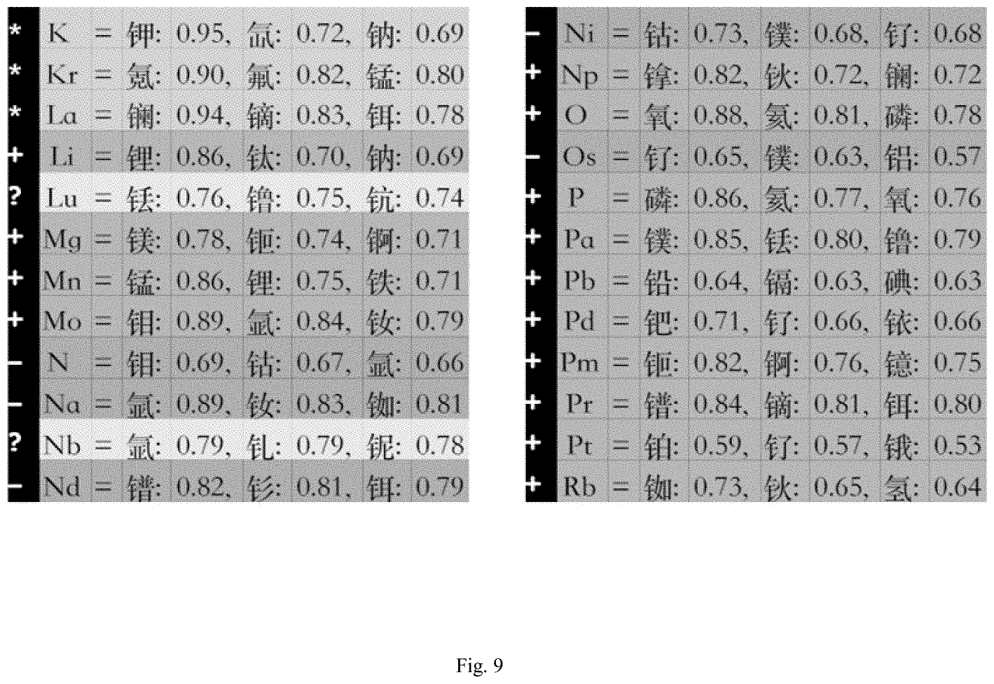

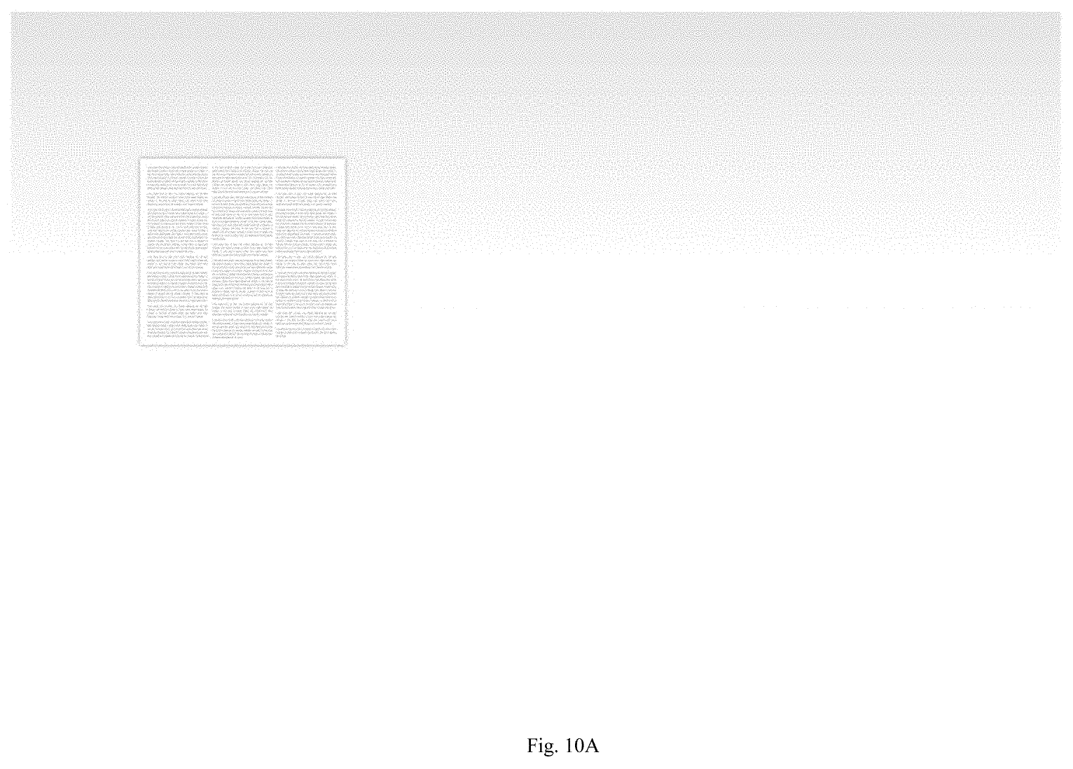

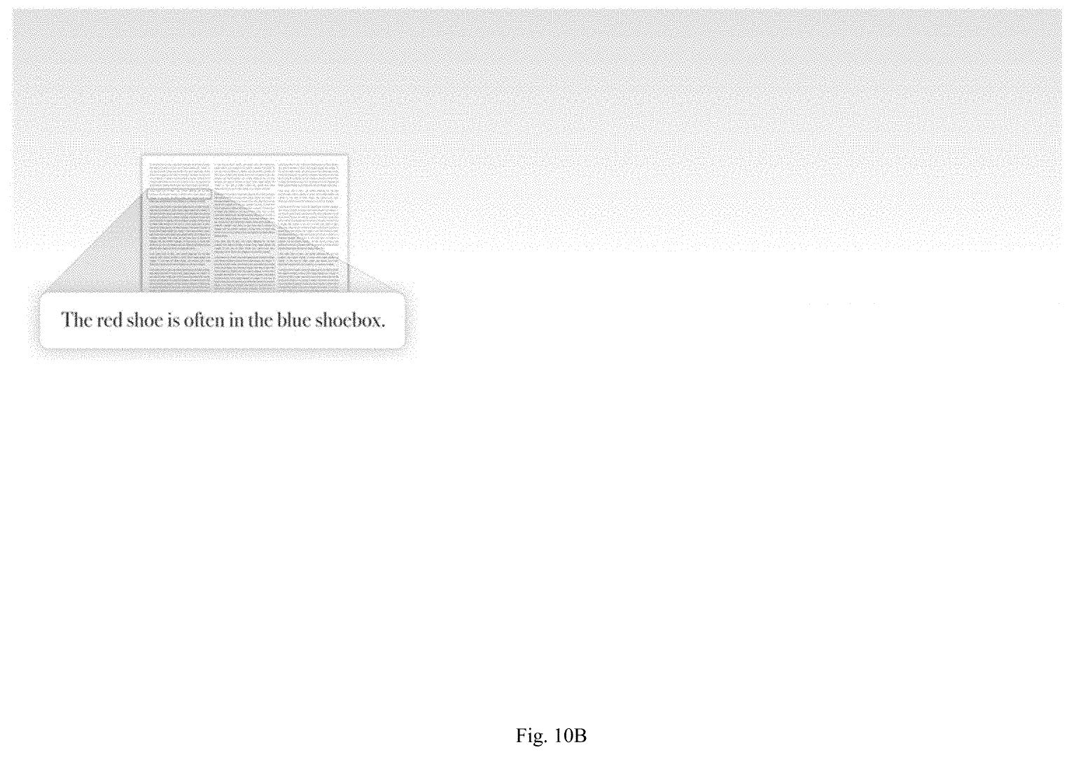

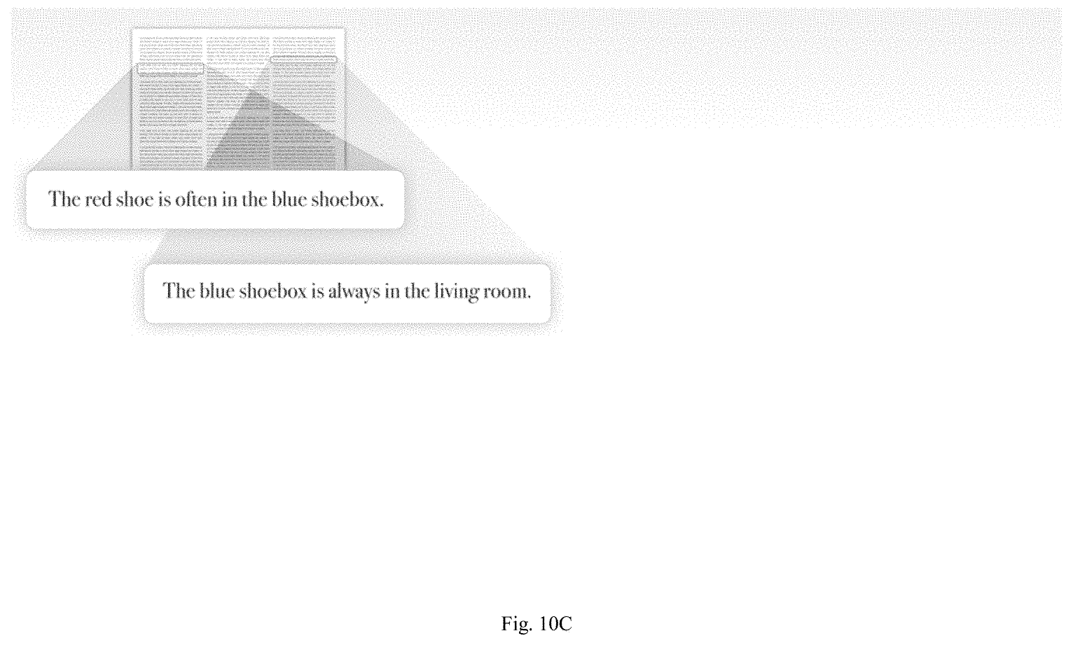

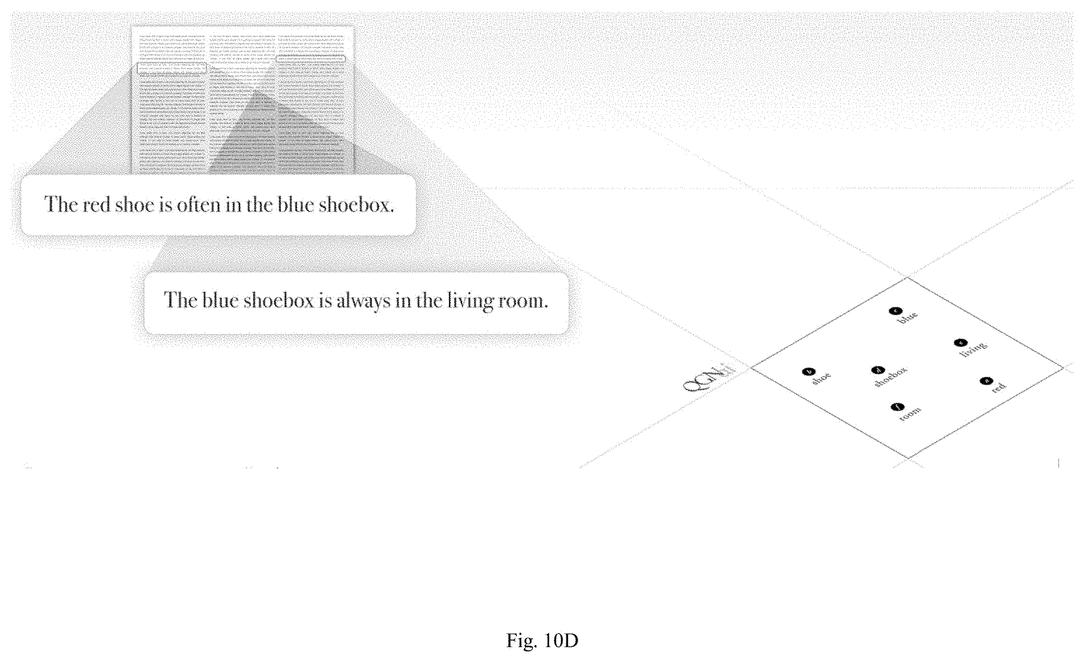

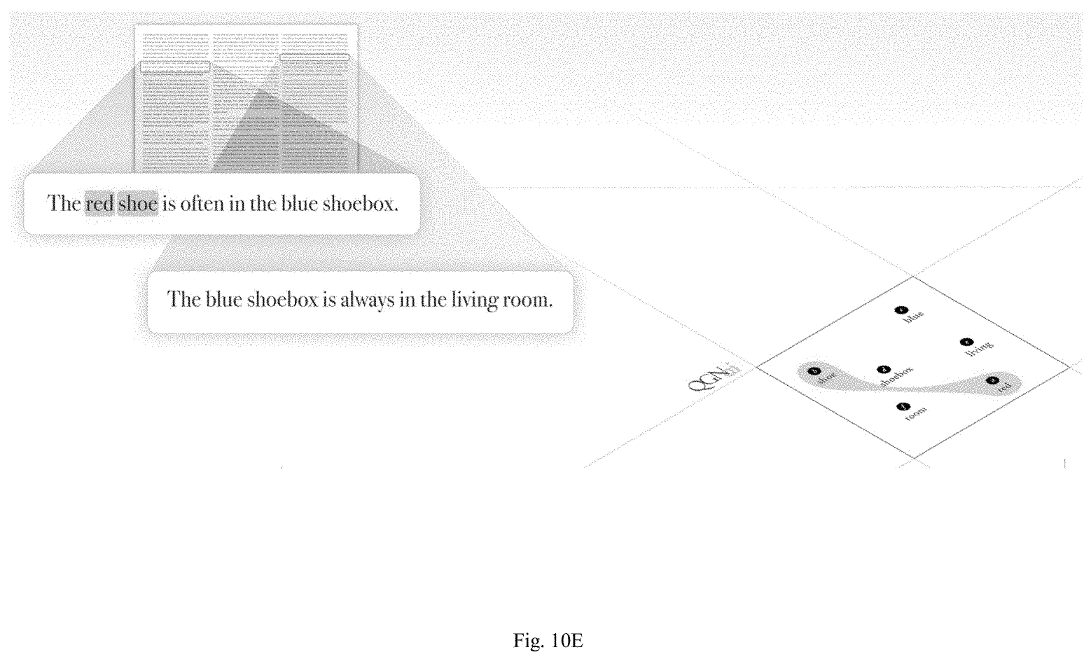

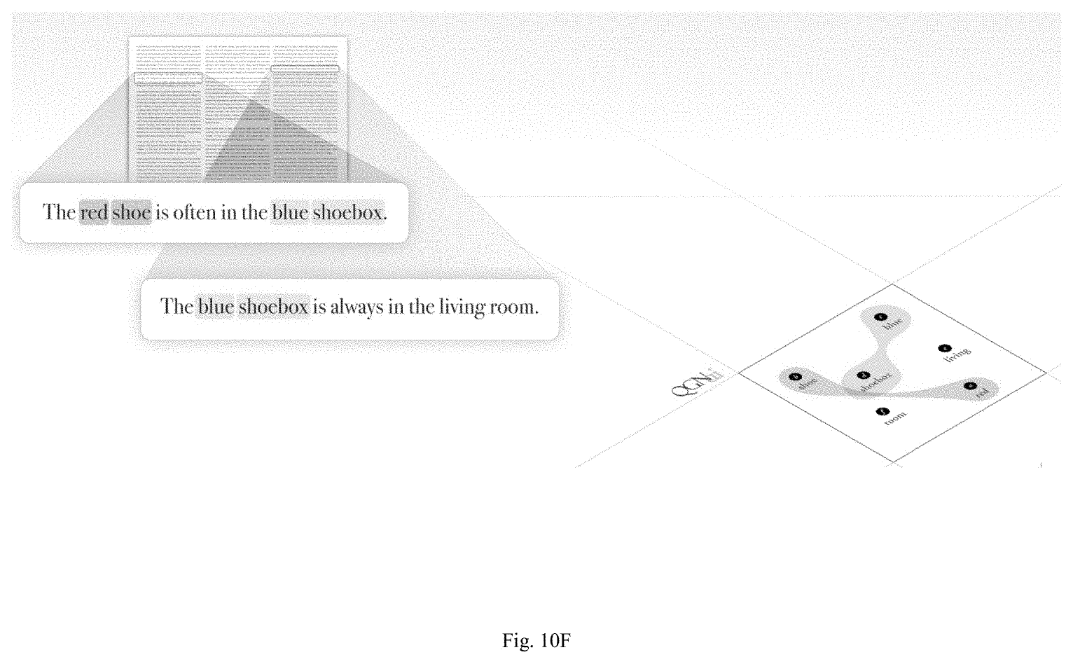

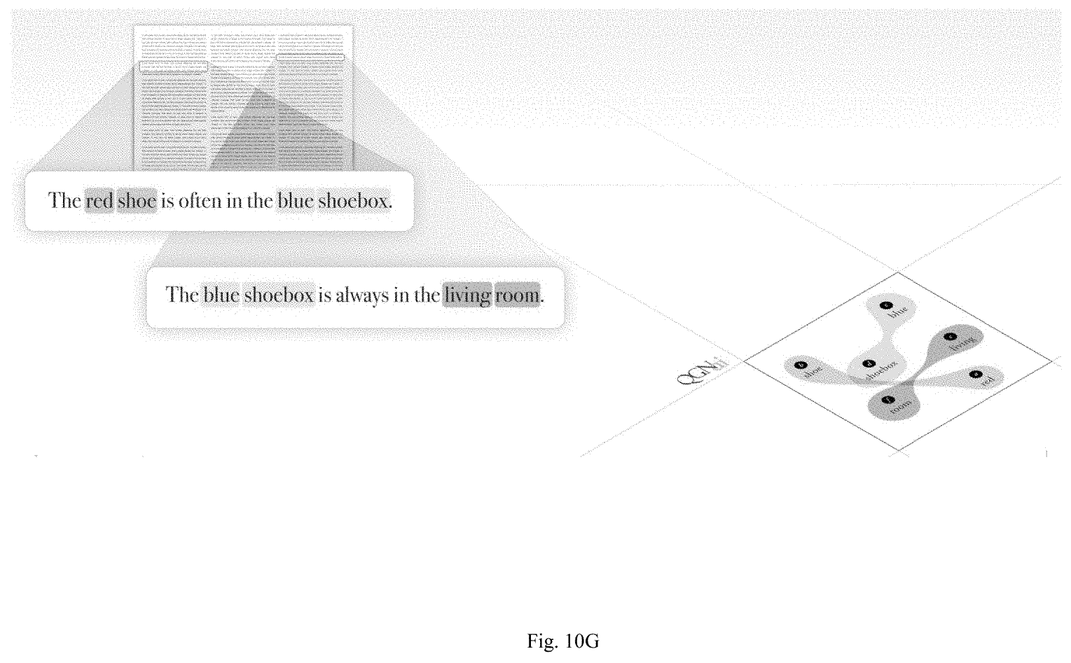

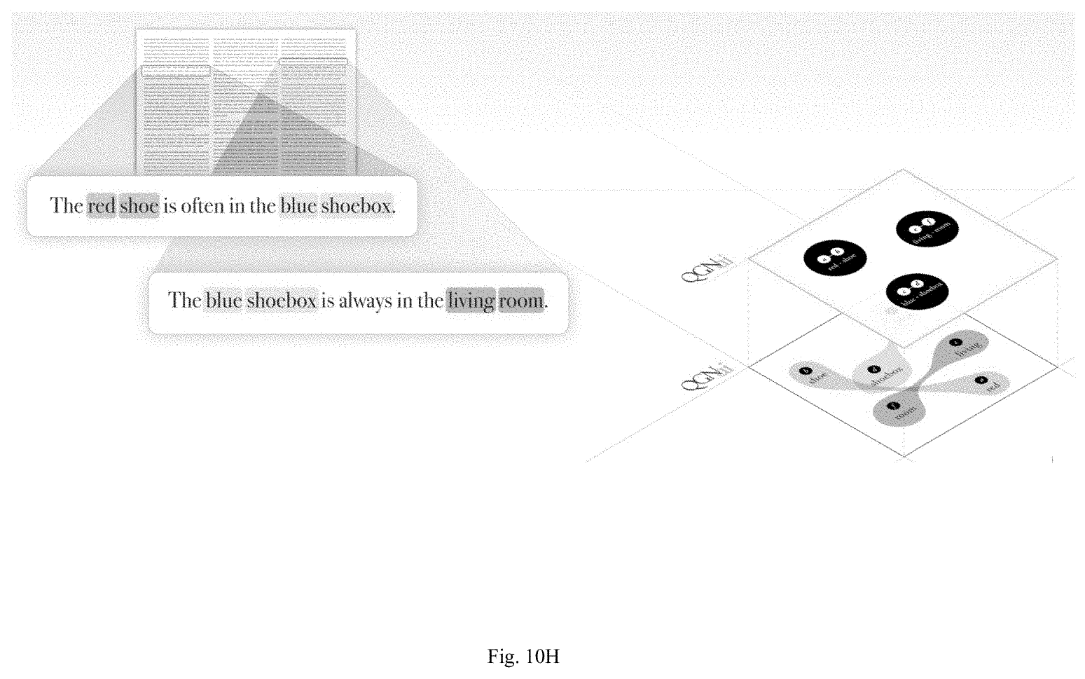

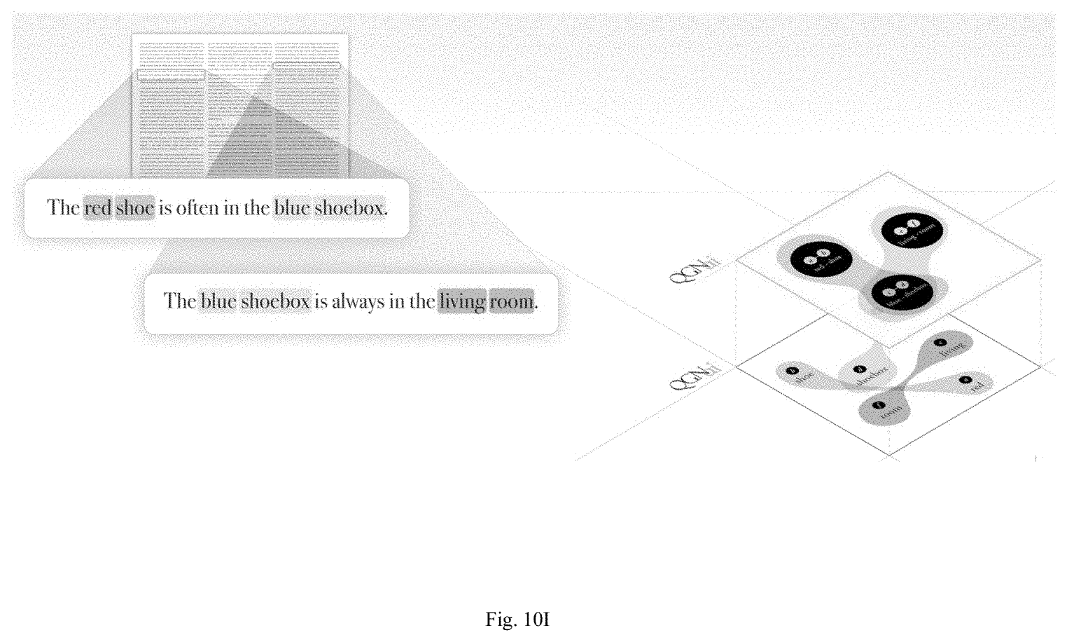

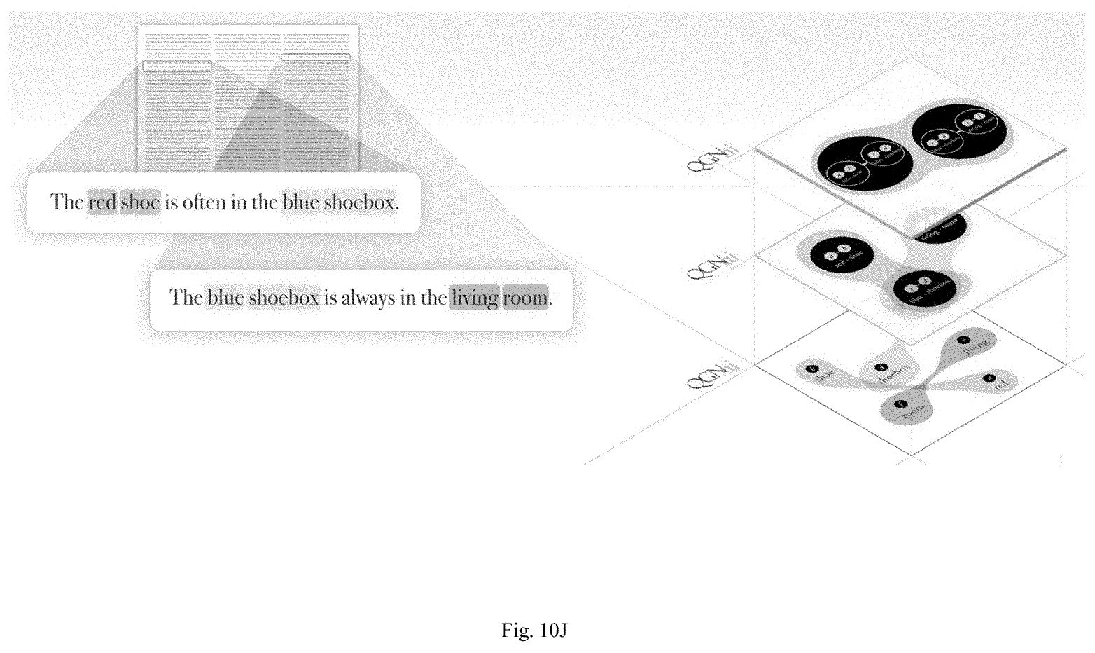

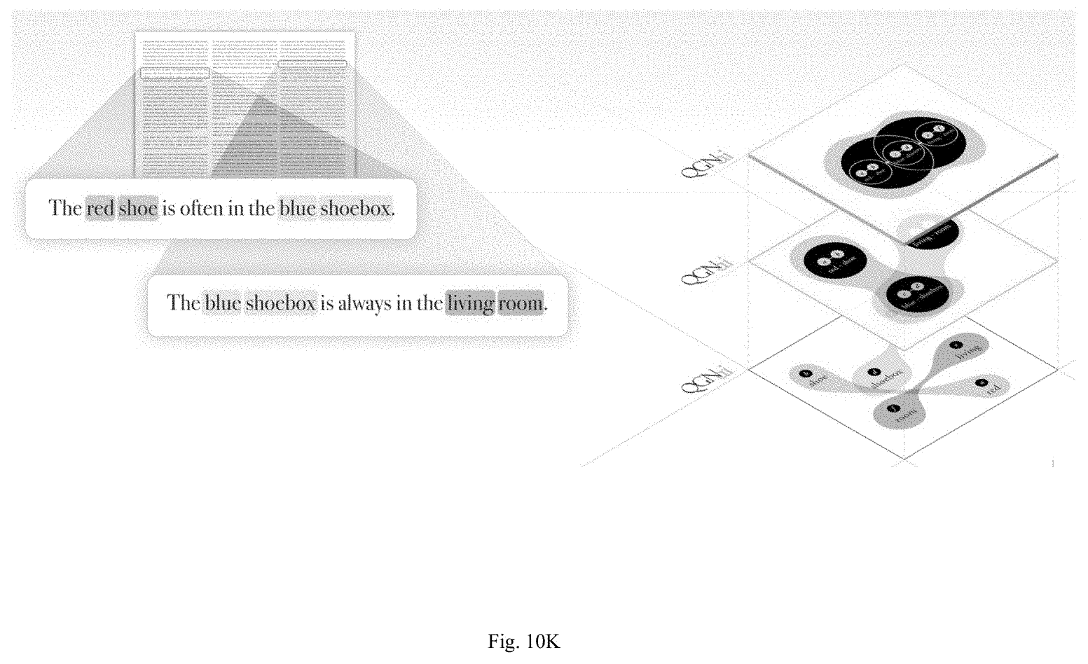

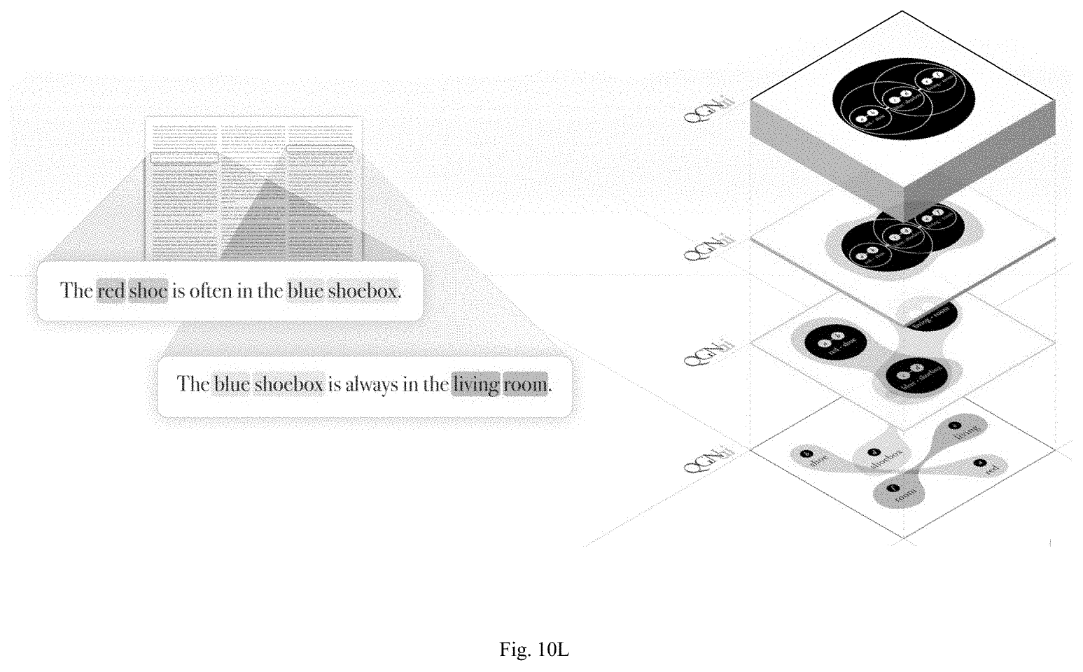

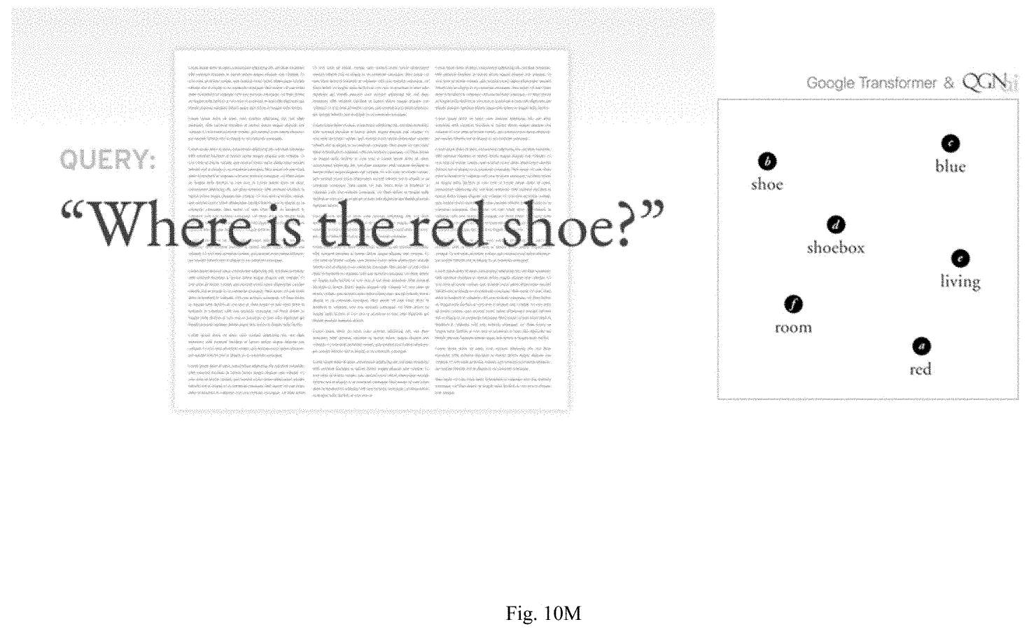

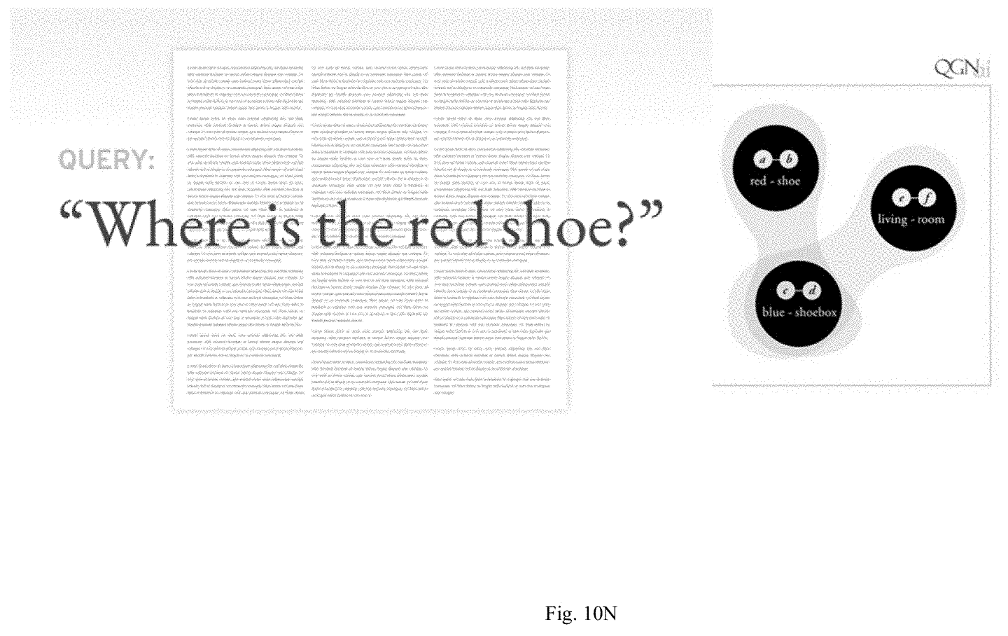

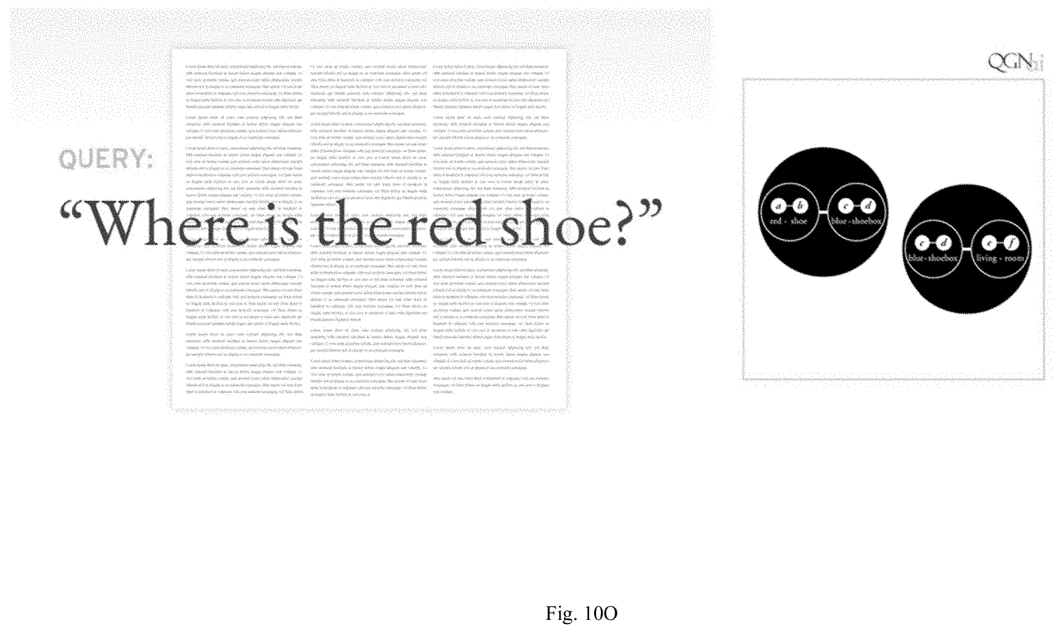

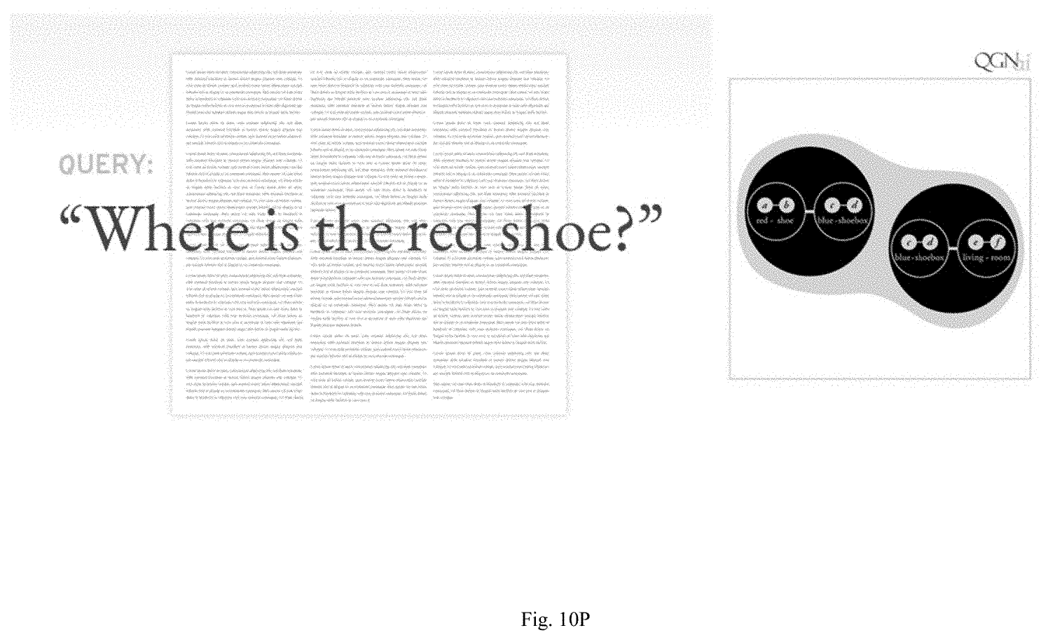

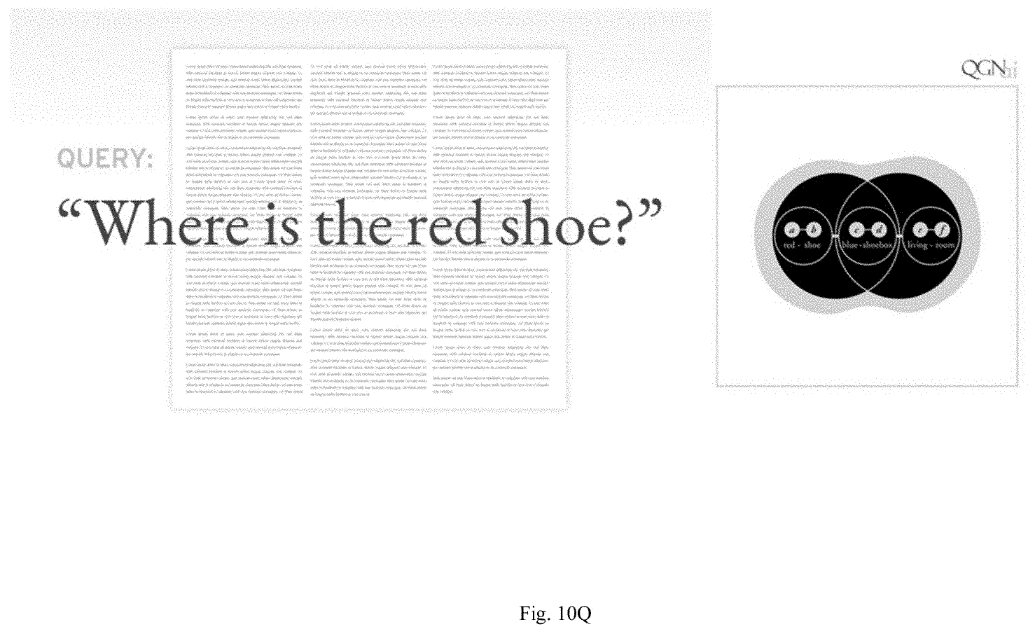

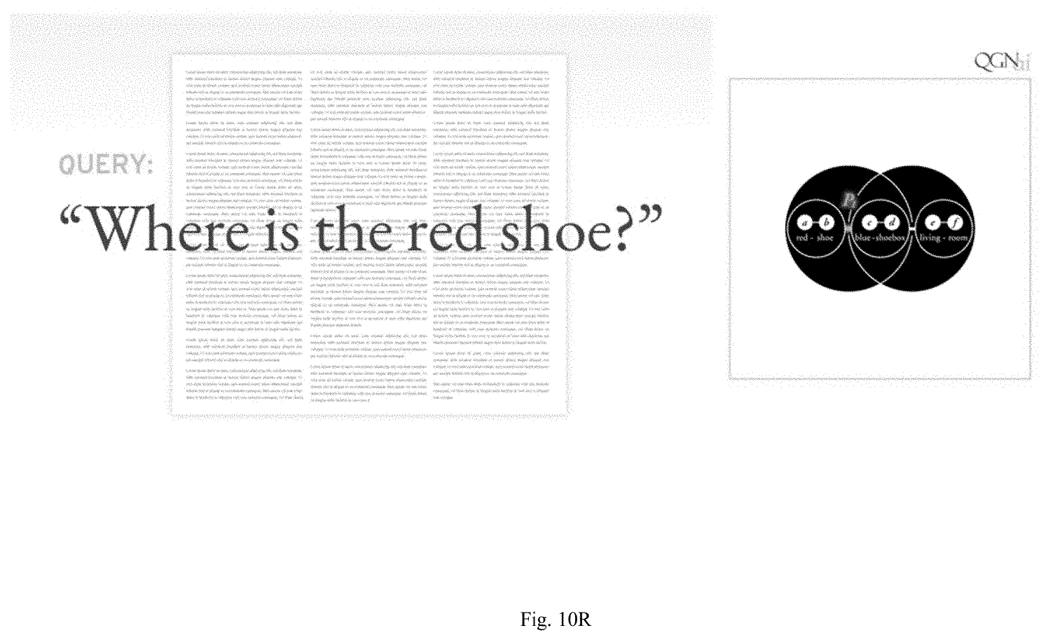

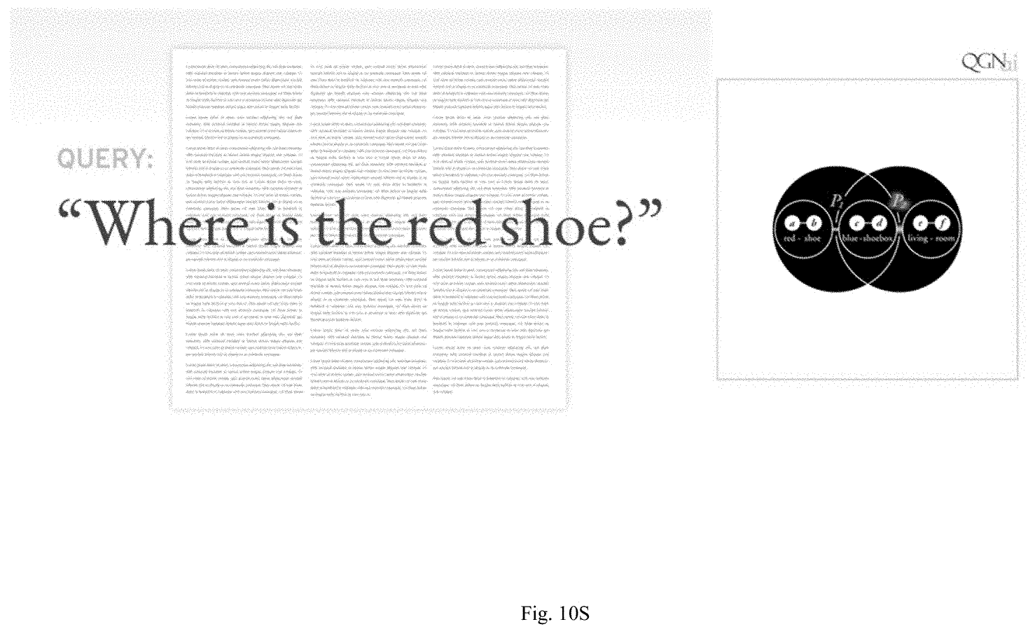

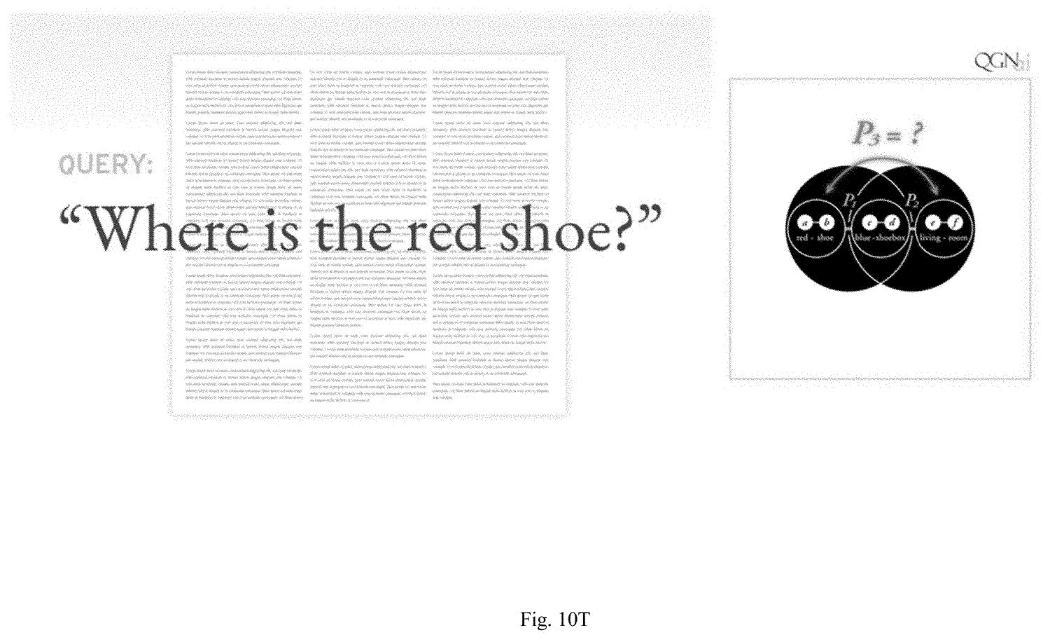

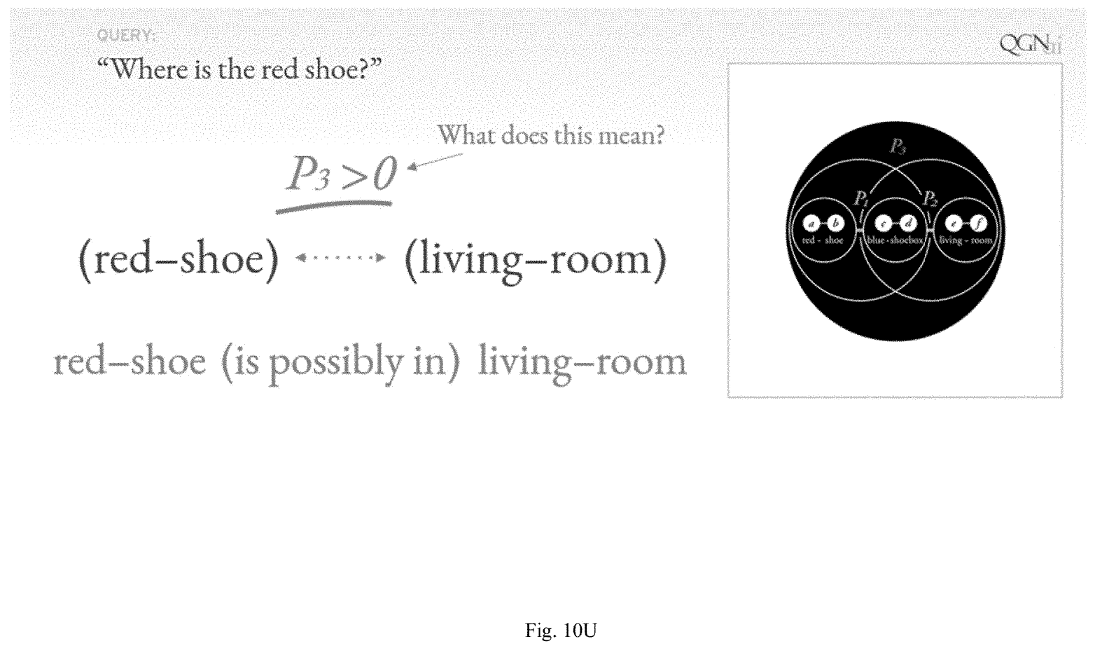

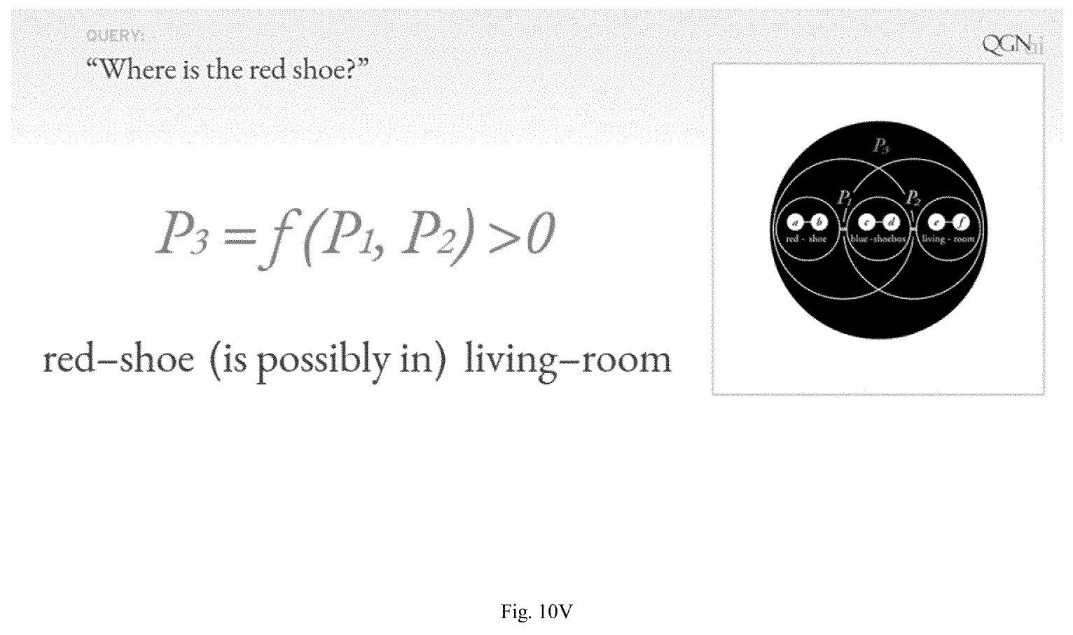

To demonstrate the categorical representation learning and the functorial learning in Task 1 and 2, an unsupervised translation task was designed with the chemical compound data set. The data set in English is taken and each element is translated into Chinese. FIG. 9 shows some samples from both the English and Chinese data set.

The task of unsupervised (or semisupervised) translation is to learn to translate chemical compounds from one language to another without aligned samples (or with only a few aligned samples). The unsupervised translation is possible because the chemical relation between elements are identical in both languages. The categorical representation learning can capture these relations and represent them as morphism embeddings. By aligning the morphism embeddings using the funtorial learning approach, the translator can be learned as a functor that maps between the English and Chinese compound categories. The translation functor is required to map elements to elements while preserving their relations. The semisupervised translation is demonstrated. A total 15 elements are assigned as supervised data and the aligned English-Chinese element pairs are provided to the machine. By minimizing the structure and alignment loss together, the translator is able to be trained.

FIG. 9 illustrates the results semisupervised translation. For each English element, the top three Chinese translations are listed. The gray lines are selected supervised elements. The row is green if the correct translation is the top candidate. The row is yellow if the correct translation is not the top candidate but appears within top three. The row is red if the correct translation does not appear even within the top-three candidates.

### CONCLUSION

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms first, second, etc. may be used herein to describe various elements, these elements should not be limited by these terms. These terms are only used to distinguish one element from another. For example, a first subject could be termed a second subject, and, similarly, a second subject could be termed a first subject, without departing from the scope of the present disclosure. The first subject and the second subject are both subjects, but they are not the same subject.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting (the stated condition or event (” or “in response to detecting (the stated condition or event),” depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method for performing a machine learning task involving a first category and a second category, the method comprising:
at a computer system comprising at least one processor and a memory storing at least one program for execution by the at least one processor, the at least one program comprising instructions for:
A) obtaining a first plurality of object embeddings for a first dataset, wherein the first dataset comprises a first plurality of objects of a first category, and wherein each respective object embedding in the first plurality of object embeddings is a respective vector representing a plurality of properties of a different object in the first plurality of objects within a first concurrence scope;
B) using the first plurality of object embeddings to determine a first plurality of morphism embeddings for a first plurality of morphisms for the first dataset, wherein each respective morphism embedding in the first plurality of morphism embeddings represents a morphism in the first plurality of morphisms between a respective first and second object in the first plurality of objects in the form of a corresponding matrix, wherein the corresponding matrix, when multiplied by the object embedding of the respective first object in the first plurality of object embeddings, realizes with a first threshold probability the object embedding of the respective second object in the first plurality of object embeddings;
C) obtaining a second plurality of object embeddings for a second dataset, wherein the second dataset comprises a second plurality of objects of a second category, and wherein each respective object embedding in the second plurality of object embeddings is a respective vector representing a plurality of properties of a different object in the second plurality of objects within the first concurrence scope;
D) using the second plurality of object embeddings to determine a second plurality of morphism embeddings for a second plurality of morphisms for the second dataset, wherein each respective morphism embedding in the second plurality of morphism embeddings represents a morphism in the second plurality of morphisms between a respective first and second object in the second plurality of objects in the form of a corresponding matrix, wherein the corresponding matrix, when multiplied by the object embedding of the respective first object in the second plurality of object embeddings, realizes with a second threshold probability the object embedding of the respective second object in the second plurality of object embeddings;
E) refining a first functor between the first category and the second category by optimizing a weighted combination of (i) a universal structure loss over each corresponding pair of morphism embeddings in the first and second plurality of morphism embeddings and (ii) an alignment loss over a subset of supervised object embeddings taken from the first and second plurality of object embeddings; and
F) using the first functor to equate a query object in the first category to a target object in the second category thereby performing a machine learning task between a first dataset to a second dataset.

2. The method of claim 1, wherein the machine learning task is a translation between one or more objects in the first category to one or more corresponding objects in the second category.

3. The method of claim 2, wherein each object in the first dataset is a corresponding set of one or more related images and each object in the second dataset is a word or a phrase.

4. The method of claim 2, wherein
each object in the first dataset is a word or phrase in a first language,
each object in the second dataset is a word or phrase in a second language,
the first dataset comprises a first plurality of documents written in the first language, and
the second dataset comprises a second plurality of documents written in the first language.

5. The method of claim 1, wherein the universal structure loss over each corresponding pair of morphism embeddings in the first and second plurality of morphism embeddings, [symbol] _{struc}, has the form: [symbol]
_{struc}=Σ_{f}∥ [symbol] − [symbol] M_{f}∥²,
wherein,
f is a morphism in the first plurality of morphisms,
M_{f} is a morphism embedding in the first plurality of morphism embeddings, [symbol]
is the morphism in the second plurality of morphism embeddings corresponding to M_{f}, and [symbol]
is the first functor.

6. The method of claim 5, wherein the alignment loss over the subset of corresponding object embeddings in the first and second plurality of object embeddings has the form: [symbol]
_{align}= [symbol] ∥ [symbol] − [symbol] vₐ∥²,
wherein,
a is an object in the first plurality of objects, [symbol]
is the first plurality of objects,
vₐ is an object embedding in the first plurality of object embeddings that represents a, and [symbol]
is an object embedding in the second plurality of object embeddings that represents the object in the second plurality of object embeddings that corresponds to a.

7. The method of claim 1, wherein the subset of supervised object embeddings taken from the first and second plurality of object embeddings represents less than one percent of the object embeddings in the first and second plurality of object embeddings.

8. The method of claim 1, wherein the subset of supervised object embeddings taken from the first and second plurality of object embeddings represents less than 0.1 percent of the object embeddings in the first and second plurality of object embeddings.

9. The method of claim 1, the method further comprising, prior to the refining E), forming the subset of supervised object embeddings by labeling less than one percent of the objects in the second plurality of object embeddings using terms associated with the first category.

10. The method of claim 1, the method further comprising, prior to the refining E), forming the subset of supervised object embeddings by labeling less than thirty percent of the objects in the second plurality of object embeddings using terms associated with the first category.

11. The method of claim 1, wherein a respective morphism embedding in the first plurality of morphism embeddings representing a morphism between a respective first object a and a respective second object b in the first plurality of objects is determined by refining a loss function that includes a linking probability between a and b and an unlinking probability for a set of pairs (a, b′), wherein each respective b′ in the set of pairs is an object in the first plurality of objects.

12. The method of claim 11, wherein the loss function [symbol] has the form
$$ℒ = {𝔼}_{( a , b ) ∼ p ( a , b )} ( log P ( a \to b ) ) + {𝔼}_{( a ) ∼ p ( a )} ( {𝔼}_{{b}^{′} ∼ {p}_{N} ( {b}^{′} )} ( log ( 1 - P ( a \to {b}^{′} ) ) ) ) , \\ wherein , \\ P ( a \to b ) = sigmoid ( z ( a \to b ) ) ≡ \frac{{e}^{z ( a \to b )}}{1 + {e}^{z ( a \to b )}} , \\ z ( a \to b ) = {agg}_{f} z ( a {\to }^{f} b ) , \\ z ( a {\to }^{f} b ) = {v}_{b}^{T} {M}_{f} {v}_{a} ,$$
M_{f} is a respective morphism embedding representing the morphism f between a and b,
vₐ is the object embedding of a in the first plurality of object embeddings,
v_{b}^{T} is a transpose of the object embedding of b in the first plurality of object embeddings,
$$z ( a {\to }^{f} b )$$
is a score function that evaluates the respective morphism f between a and b, given by v_{b}^{T}M_{f} vₐ, or by a neural network that takes M_{f}, vₐ, and v_{b} as input and returns a scalar score,
$${agg}_{f} z ( a {\to }^{f} b )$$
is an aggregation of the score for the morphism f between a and b into a final score z(a→b),
z(a→b) is a logit that determines P(a→b),
P(a→b) is a linking probability that a and b are related by one or more morphisms,
1−P(a→b′) is an unlinking probability describing a probability that a and b are not related by one or more morphisms,
$${𝔼}_{( a , b ) ∼ p ( a , b )} ( log P ( a \to b ) )$$
is expectation of the log likelihood of the linking probability given (a, b)˜p (a, b),
(a, b)˜p(a, b) is a sampling distribution across pairs of objects in the first concurrence scope drawn from the first dataset,
$${𝔼}_{( a ) ∼ p ( a )} ( {𝔼}_{{b}^{′} ∼ {p}_{N} ( {b}^{′} )} ( log ( 1 - P ( a \to {b}^{′} ) ) ) )$$
is the expectation of the log likelihood of the unlinking probability given (a)˜p(a), and b′˜p_{N}(b′),
a˜p (a) is a marginal distribution of a across objects drawn from the first dataset, and
b′˜p_{N}(b′) is a negative sampling distribution of b′ across objects drawn from the first dataset.

13. The method of claim 12, wherein
p(a)=Σ_{b}p(a, b) and is a marginalization of the joint distribution p(a, b) of concurrence probability, and
p_{N}(b′) can either be taken as the marginal distribution or a fractional power p_{N}(b′)^{k} of the marginal distribution.

14. The method of claim 11, wherein the loss function is optimized by gradient decent or gradient ascent.

15. The method of claim 12, wherein refining the loss function comprises encoding each matrix value for M_{f} as a corresponding hidden weight in a neural network that is configured to solve for v_{b}^{T}M_{f} vₐ upon inputting vₐ and v_{b} into the neural network and using the output of the neural network upon inputting vₐ and v_{b} to refine each matrix value for M_{f} in accordance with the loss function.

16. The method of claim 1, wherein
the first plurality of objects comprises more than fifty objects,
the first plurality of object embeddings comprises more than fifty object embeddings, and
the first plurality of morphism embeddings comprises more than fifty morphism embeddings.

17. The method of claim 1, the method further comprising:
determining a linking probability P(a→b) between a first object a and a second object b in first plurality of objects, and
adding a corresponding composite object v_{a\textcircled{×}b} to the first plurality of objects when the linking probability P(a→b) exceeds a threshold value.

18. The method of claim 17, wherein the corresponding composite object v_{a\textcircled{×}b} is calculated as a tensor bifunctor
v_{a\textcircled{×}b}=Φ(vₐ\textcircled{×}v_{b}),
wherein,
vₐ\textcircled{×}v_{b} is implemented as a Kronecker product, and
Φ is a projection matrix that maps vₐ\textcircled{×}v_{b} to v_{a\textcircled{×}b} linearly, or a neural network that maps vₐ\textcircled{×}v_{b} to v_{a\textcircled{×}b} non-linearly.

19. The method of claim 17, wherein
the first plurality of objects comprises a plurality of elemental objects and a plurality of composite objects, and the method further comprises:
tracking, for each respective composite object in the plurality of composite objects, a number of elemental objects used to form the respective composite object.

20. The method of claim 1, the method further comprising:
obtaining a third plurality of object embeddings for the first dataset, wherein each respective object embedding in the third plurality of object embeddings is a respective vector representing a plurality of properties of a different object in the first plurality of objects within a second concurrence scope;
the second concurrence scope is different from the first concurrence scope,
a respective morphism embedding in the first plurality of morphism embeddings representing a morphism between a respective first object a and a respective second object b in the first concurrence scope in the first plurality of objects is determined by refining a first loss function that includes a linking probability between a and b, P(a→b), and an unlinking probability for a first set of pairs (a, b), wherein each b′ in the first set of pairs is an object in the first plurality of objects in the first concurrence scope that is not identified as linked with a, and
a respective morphism embedding in the first plurality of morphism embeddings representing a morphism between a respective first object c and a respective second object din the second concurrence scope in the first plurality of objects is determined by refining a second loss function that includes a linking probability between c and d, P(c→d), and an unlinking probability for a second set of pairs (c, d′), wherein each d′ in the second set of pairs is an object in the second plurality of objects in the second concurrence scope that is not identified as linked with c.

21. The method of claim 1, wherein each object embedding in the first plurality of object embeddings is obtained using a skip-gram method, a common bag of words method, or a skip-gram negative sampling method.

22. The method of claim 1, wherein the machine learning task comprises natural language processing, fulfillment of a search engine, reinforcement learning, security or drug discovery.

23. A computer system for performing a machine learning task involving a first category and a second category, the computer system comprising:
at least one processor; and
a memory storing at least one program for execution by the at least one processor, the at least one program comprising instructions for:
A) obtaining a first plurality of object embeddings for a first dataset, wherein the first dataset comprises a first plurality of objects of a first category, and wherein each respective object embedding in the first plurality of object embeddings is a respective vector representing a plurality of properties of a different object in the first plurality of objects within a first concurrence scope;
B) using the first plurality of object embeddings to determine a first plurality of morphism embeddings for a first plurality of morphisms for the first dataset, wherein each respective morphism embedding in the first plurality of morphism embeddings represents a morphism in the first plurality of morphisms between a respective first and second object in the first plurality of objects in the form of a corresponding matrix, wherein the corresponding matrix, when multiplied by the object embedding of the respective first object in the first plurality of object embeddings, realizes with a first threshold probability the object embedding of the respective second object in the first plurality of object embeddings;
C) obtaining a second plurality of object embeddings for a second dataset, wherein the second dataset comprises a second plurality of objects of a second category, and wherein each respective object embedding in the second plurality of object embeddings is a respective vector representing a plurality of properties of a different object in the second plurality of objects within the first concurrence scope;
D) using the second plurality of object embeddings to determine a second plurality of morphism embeddings for a second plurality of morphisms for the second dataset, wherein each respective morphism embedding in the second plurality of morphism embeddings represents a morphism in the second plurality of morphisms between a respective first and second object in the second plurality of objects in the form of a corresponding matrix, wherein the corresponding matrix, when multiplied by the object embedding of the respective first object in the second plurality of object embeddings, realizes with a second threshold probability the object embedding of the respective second object in the second plurality of object embeddings;
E) refining a first functor between the first category and the second category by optimizing a weighted combination of (i) a universal structure loss over each corresponding pair of morphism embeddings in the first and second plurality of morphism embeddings and (ii) an alignment loss over a subset of supervised object embeddings taken from the first and second plurality of object embeddings; and
F) using the first functor to equate a query object in the first category to a target object in the second category thereby performing a machine learning task between a first dataset to a second dataset.

24. A non-transitory computer-readable storage medium having stored thereon program code instructions that, when executed by a processor, cause the processor to perform a method of performing a machine learning task involving a first category and a second category, the method comprising:
at a computer system comprising at least one processor and a memory storing at least one program for execution by the at least one processor, the at least one program comprising instructions for:
A) obtaining a first plurality of object embeddings for a first dataset, wherein the first dataset comprises a first plurality of objects of a first category, and wherein each respective object embedding in the first plurality of object embeddings is a respective vector representing a plurality of properties of a different object in the first plurality of objects within a first concurrence scope;
B) using the first plurality of object embeddings to determine a first plurality of morphism embeddings for a first plurality of morphisms for the first dataset, wherein each respective morphism embedding in the first plurality of morphism embeddings represents a morphism in the first plurality of morphisms between a respective first and second object in the first plurality of objects in the form of a corresponding matrix, wherein the corresponding matrix, when multiplied by the object embedding of the respective first object in the first plurality of object embeddings, realizes with a first threshold probability the object embedding of the respective second object in the first plurality of object embeddings;
C) obtaining a second plurality of object embeddings for a second dataset, wherein the second dataset comprises a second plurality of objects of a second category, and wherein each respective object embedding in the second plurality of object embeddings is a respective vector representing a plurality of properties of a different object in the second plurality of objects within the first concurrence scope;
D) using the second plurality of object embeddings to determine a second plurality of morphism embeddings for a second plurality of morphisms for the second dataset, wherein each respective morphism embedding in the second plurality of morphism embeddings represents a morphism in the second plurality of morphisms between a respective first and second object in the second plurality of objects in the form of a corresponding matrix, wherein the corresponding matrix, when multiplied by the object embedding of the respective first object in the second plurality of object embeddings, realizes with a second threshold probability the object embedding of the respective second object in the second plurality of object embeddings;
E) refining a first functor between the first category and the second category by optimizing a weighted combination of (i) a universal structure loss over each corresponding pair of morphism embeddings in the first and second plurality of morphism embeddings and (ii) an alignment loss over a subset of supervised object embeddings taken from the first and second plurality of object embeddings; and
F) using the first functor to equate a query object in the first category to a target object in the second category thereby performing a machine learning task between a first dataset to a second dataset.
